(19) United States
(12) Patent Application Publication
(10) Pub. No.: US 2026/0318867 A1
(43) Pub. Date: Oct. 15, 2026

(54) OXYGEN SENSOR USING ZINC-AIR BATTERY CHEMISTRY

(71) Applicant: THE REGENTS OF THE UNIVERSITY OF CALIFORNIA, Oakland, CA (US)

(72) Inventors: Carol Louise Baumbauer, Berkeley, CA (US); Ana Claudia Arias, Lafayette, CA (US); Philothei Sahinidis, Berkeley, CA (US)

(21) Appl. No.: 19/401,067

(22) Filed: Nov. 25, 2025

Related U.S. Application Data
(60) Provisional application No. 63/725,793, filed on Nov. 27, 2024.

(51) Int. Cl. G01N 27/416

(52) U.S. Cl. CPC G01N 27/4162

(57) ABSTRACT

Electrochemical sensors and methods for the electrochemical sensing of oxygen using zinc-air battery chemistry are disclosed herein. The electrochemical sensor may comprise an anode comprising: an anode substrate; and a first current collector; a cathode in ionic communication with the anode comprising: a gas permeable cathode substrate; and a second current collector; a separator positioned between the anode and the cathode; wherein the separator comprises an electrolyte and establishes ionic communication between the anode and the cathode; and an electronic unit configured to electrically couple the anode with the cathode and to receive from the anode and the cathode one or more electrical signals indicative of a level of oxygen in an ambient environment.

### CROSS-REFERENCE TO RELATED APPLICATION

This application claims the benefit of priority to U.S. Provisional Patent Application No. 63/725,793, filed Nov. 27, 2024, which is hereby incorporated by reference in its entirety.

### FEDERALLY SPONSORED RESEARCH OR DEVELOPMENT

This invention was made with Government support under contract DE-AR0001602 awarded by Department of Energy. The Government has certain rights in this invention.

### SUMMARY

Historical oxygen sensors comprise galvanic cells that rely on lead (Pb) as the anode metal. Because of the toxicity of lead, modern galvanic O₂ sensors may also use bismuth and its alloys. These commercial galvanic oxygen sensors have a lifetime of 2-10 years but can be expensive (e.g., cost a few hundred dollars each), severely limiting their scalability for collecting high temporal and high spatial resolution oxygen data, which is important in applications such as industrial manufacturing to track chemical processes or oxygen leaks, wildfire monitoring to track combustion reactions, medical applications to monitor patients' breathing, soil biogeochemical studies, air quality studies, monitoring car emissions, laboratory settings, and aerospace/astronaut safety.

High temporal and high spatial resolution oxygen data, relevant in the aforementioned applications, may be facilitated by low-cost and scalable oxygen sensors. However, current oxygen sensing technologies are limited by high costs and the use of toxic materials. Sensors based on metal-air redox chemistry, e.g., zinc-air battery chemistry, may rely on more abundant and environmentally friendly materials than presently available galvanic oxygen sensors, and offer very low cost and low power oxygen monitoring. Commercially available metal-air batteries include zinc-air hearing aid batteries. Custom-made fabricated electrochemical cells designed for improved sensitivity or robustness may also be used as oxygen sensors depending on the intended application. The advantage of custom-made cells include their customizability to the specific application. For example, customized electrochemical cells may include specific geometries, sizes, ratios of materials, or additional materials and layers that improve the performance (lifetime, sensitivity, stability, etc.) of the oxygen sensors in a particular environment. Printing techniques may be used for scalable fabrication and the sensors can be read in a variety of ways. Measurements based on reaction kinetics and mass transport may provide fast response times while measurements based on thermodynamics may offer very low detection limits.

Provided herein are devices and methods which address the aforementioned and other challenges. In particular, the electrochemical sensor embodiments disclosed herein represent a significant advancement in oxygen sensing technology, enabling oxygen sensing in an ambient environment, for example at the point-of-care, with high spatial and high temporal resolution with devices and methods that are affordable and non-toxic compared to traditional devices and methods. The devices and methods disclosed herein are designed to measure, monitor, or record electrochemical signals generated by a zinc-air battery indicative of a level of oxygen in an ambient environment. The devices are compatible with various electrochemical techniques including, but not limited to, amperometry, potentiometry, voltammetry, or impedance. Zinc-air batteries as oxygen sensors offer several advantages over existing galvanic and optical oxygen sensors. They are inexpensive—a battery costs 10 cents or less, compared to $100 or more for oxygen sensors today. Zinc-air batteries are made of abundant, nontoxic, and biodegradable materials, namely zinc and carbon. Alternative galvanic oxygen sensors have been made from toxic materials such as lead, or rare materials such as bismuth/antimony alloys. Like any galvanic sensor, the sensor's signal is generated without an external power supply, unlike an optical probe which must be powered. Indeed, it may be possible to power the readout electronics with the sensor itself. Sensors in various electrochemical modes may offer various characteristics that can be selected based on the application, for example, sensors in potentiometric mode may offer very low detection limits for applications in which oxygen concentrations are low.

Provided herein are electrochemical sensors comprising: an anode comprising: an anode active layer; a cathode in ionic communication with the anode, the cathode comprising: a cathode active layer; a separator positioned between the anode and the cathode; wherein the separator comprises an electrolyte and establishes ionic communication between the anode and the cathode; and an electronic unit configured to electrically couple the anode with the cathode and to receive from the anode and the cathode one or more electrical signals indicative of a level of oxygen in an ambient environment.

Also provided herein is a method of sensing oxygen, the method comprising: A method of sensing oxygen, the method comprising: providing an electrochemical sensor comprising: an anode, a cathode, and a separator comprising an electrolyte positioned between the anode and the cathode; wherein the anode and the cathode are electrically coupled via an electronic unit configured to receive one or more electrical signals indicative of a level of oxygen and in ionic communication via the separator; wherein the anode is an active anode layer comprising a metal or metal alloy; wherein the cathode is an active cathode layer comprising an oxygen reduction catalyst; providing a sample, controlling a rate of diffusion of oxygen from the sample into the electrochemical sensor; delivering oxygen to the cathode such that the oxygen at least partially contacts the oxygen reduction catalyst; and measuring one or more electrical signals indicative of the level of oxygen in the sample gas with the electronic unit.

Also provided herein is a method of fabricating an electrochemical sensor for sensing oxygen, the method comprising: printing an anode ink on a first current collector layer to form a printed anode active layer; printing a cathode ink on a second current collector layer to form a printed cathode active layer; providing a separator disposed between the printed anode active layer and the printed cathode active layer; wherein the separator comprises an electrolyte; assembling the sensor such that the printed anode active layer and the printed cathode active layer are in ionic communication via the separator and electrically coupled via an electronic unit configured to receive one or more electrical signals indicative of a level of oxygen in an ambient environment.

In an embodiment of any of the sensors or methods disclosed herein, optionally, the anode may further comprise an anode substrate, a first current collector, or a combination thereof. The anode active layer may also be configured to act as the current collector, for example, some metals may have an electronic conductivity enabling sufficient current to pass to act as current collector. The anode substrate may be optional in certain embodiments as long as the other components play a role similar to the anode substrate. For example, the anode substrate may be configured to provide physical support for the anode active material and the current collector. In addition, the anode substrate may be configured to prevent gas from diffusing in through the back of the cell. Thus, if the cell is built, for example, with a sheet of zinc metal or foil, an additional plastic substrate or other substrate material may not be needed.

In an embodiment of any of the sensors or methods disclosed herein, optionally, the cathode may further comprise a cathode substrate and a second current collector. The cathode active layer may also be configured to act as the current collector, for example, some metals may have an electronic conductivity enabling sufficient current to pass to act as a current collector, for example, as the second current collector. Those same metals may also be catalytic enabling their use as an active cathode layer. The cathode substrate may be optional in certain embodiments as long as the other components play a role similar to the cathode substrate. For example, the cathode substrate may provide structural support for the cathode active layer and/or the cathode current collector. Thus, a cathode substrate may not be needed if, for example, the cathode active layer comprises carbon paper or metal mesh.

In an embodiment of any of the sensors or methods disclosed herein, the anode and the cathode may further be operable via the electronic unit to generate the one or more electrical signals indicative of the level of oxygen in the ambient environment using one of amperometric detection, potentiometric detection, impedimetric detection, voltammetric detection, or any combination of these. Other alternative sensing techniques may include generating the one or more electrical signals indicative of the level of oxygen in the ambient environment by short circuiting the sensor and measuring the recovery time or by drawing a controlled current and measuring the potential of the sensor. The type of detection may be selected based on the specific application. For example, if faster readout times are applicable, amperometric detection may be preferred. Alternatively, potentiometric detection, based on electrochemical cell thermodynamics, may provide lower detection limits in applications where oxygen concentrations are low.

In an embodiment of any of the sensors or methods disclosed herein, the electronic unit may further comprise circuitry including one or more resistors, one or more operational amplifiers, one or more metal oxide semiconductor (MOS) transistors, one or more bipolar junction transistors, one or more capacitors, or any combination of these. For example, amperometric sensors output a current and simple microcontroller based readout electronics measure input voltages. A simple way to convert a current to a voltage is to run the current through a small resistor, then measure the resistor's voltage. In another example, such as chronoamperometry, the voltage drop across the sensor is held constant while the current changes. The voltage drop can be held constant by using an op-amp. Therefore, the selection of electronic circuitry components may depend on the electrochemical sensing technique employed such as amperometry, voltammetry, potentiometry, and impedance.

In an embodiment of any of the sensors or methods disclosed herein, the electronic unit may be configured to process and communicate data associated with the one or more electrical signals detected by the sensor. The one or more electrical signals may include a current, a voltage, or an impedance.

In an embodiment of any of the sensors or methods disclosed herein, the cathode may be configured to catalyze a reaction between oxygen, water, and electrons to produce hydroxide ions, while at the anode, a metal or metal alloy anode active layer may be oxidized by hydroxide ions to produce a metal oxide, water, and electrons. The aforementioned electrochemical reactions may generate the electrochemical signal measured by the electronic unit. For example, the sensor may be configured to catalyze the above reactions when the anode active layer comprises zinc, the cathode active layer comprises carbon, and the electrolyte comprises KOH or another aqueous solution.

In an embodiment of any of the sensors or methods as disclosed herein, the cathode may be configured to catalyze a reaction between oxygen and electrons to produce peroxide ions, while at the anode, a metal or metal alloy anode active layer may be oxidized by peroxide ions to produce a metal ion and electrons. The aforementioned electrochemical reactions may generate the electrochemical signal measured by the electronic unit. For example, the sensor may be configured to catalyze the above reactions when the anode active layer comprises zinc, the cathode active layer comprises carbon, and the electrolyte comprises, for example, zinc trifluoromethanesulfonate.

In an embodiment of any of the sensors or methods as disclosed herein, the electrochemical reactions that occur at the anode and the cathode may generate a current which may be used to power the electrochemical sensor and readout circuitry. This embodiment may also be referred to as dual sensing/battery mode.

In an embodiment of any of the sensors or methods as disclosed herein, the cathode substrate may comprise a gas permeable cathode substrate that is permeable to oxygen to allow oxygen to diffuse through the gas permeable cathode substrate and contact the cathode to undergo an electrocatalytic reaction. In a further embodiment of any of the sensors or methods as disclosed herein, the gas permeable cathode substrate may comprise a gas permeable membrane. Optionally, the gas permeable membrane may comprise polypropylene, polytetrafluoroethylene, paper, or any combination thereof.

In an embodiment of any of the sensors or methods as disclosed herein, the anode substrate and the gas permeable cathode substrate may be electrically insulating. For example, the anode substrate and the gas permeable substrate may be fabricated from an electrically insulating material.

In an embodiment of any of the sensors or methods as disclosed herein the anode substrate may comprise a polymer, a glass, or any combination thereof. In certain embodiments, the polymer may comprise polyamide, expanded or regular polyethylene terephthalate, polyethylene naphthalate, or any combination thereof.

In an embodiment of any of the sensors or methods as disclosed herein, the anode active layer is a printed anode active layer. Optionally, the printed anode active layer may comprise an anode ink printed on the first current collector, and the anode ink may comprise a metal or metal alloy. A printed anode active layer may enable anode customization in terms of anode composition and geometry. For example, a customized anode active layer may comprise a metal or metal alloy comprising Zn, Mg, Li, Al, Fe, Na or any combination thereof. The anode ink may be customized for example based on the desired anode lifetime, anode durability, or sensing environment. The anode ink may be further customized to comprise at least 40% metal or metal alloy by mass, at least 50% metal or metal alloy by mass, at least 60% metal or metal alloy by mass, at least 70% metal or metal alloy by mass, at least 80% metal or metal alloy by mass, or at least 90% metal or metal alloy by mass.

In an embodiment of any of the sensors or methods as disclosed herein, the cathode active layer is a printed cathode active layer and the printed cathode active layer may comprise a cathode ink printed on the second current collector. The cathode ink may be customized for specific applications and customized embodiments may include carbon ink, carbon paper, carbon nanotubes, silver nanoparticles, perovskites, polytetrafluoroethylene, a metal, a metal oxide, a metal calcite, a metal carbide, a metal nitride, or any combination of these.

In an embodiment of any of the sensors or methods as disclosed herein, the anode current collector comprises a printed anode current collector and the printed anode current collector comprises an anode current collector ink. In another embodiment of the sensors or methods as disclosed herein, the cathode current collector comprises a printed cathode current collector and the printed cathode current collector comprises a cathode current collector ink.

In another embodiment of any of the sensors or methods as disclosed herein, the anode ink, the cathode ink, the anode current collector ink, the cathode current collector ink or a combination thereof, may comprise a binder, a solvent, or any combination thereof.

In an embodiment of any of the sensors or methods as disclosed herein, the binder of the anode ink, the cathode ink, the anode current collector ink, and/or the cathode current collector ink may comprise, for example polycaprolactone, polyvinylpyrrolidone, polyvinyl alcohol, polyvinyl acetate, polytetrafluoroethylene, polyvinylidene fluoride, pyridine-styrene-butadiene rubber, Poly(3-hydroxybutyrate-co-3-hydroxyvalerate), a bees wax, or a combination thereof.

In an embodiment of any of the sensors or methods as disclosed herein, the solvent may comprise anisole, tetrahydrofuran, N-methyl-2-pyrrolidone, acetone, isopropanol, water, or a combination thereof.

In another embodiment of any of the sensors or methods as disclosed herein, the anode ink may be further customized and may comprise an additive, for example useful additives may comprise zinc oxide, carbon, bismuth oxide, lead, indium, styrene butadiene, sodium silicate, polycarbonate, polyethylene glycol, an acid sinter, a photonic sinter, or any combination of these.

In an embodiment of any of the sensors or methods as disclosed herein, the cathode, cathode active layer, or cathode ink may comprise an oxygen reduction catalyst.

In an embodiment of any of the sensors or methods as disclosed herein, the oxygen reduction catalyst of the cathode may comprise carbon ink, carbon paper, carbon nanotubes, silver nanoparticles, perovskites, polytetrafluoroethylene, a metal, a metal oxide, a metal calcite, a metal carbide, a metal nitride, or any combination thereof.

In an embodiment of any of the sensors or methods as disclosed herein, the first current collector or anode current collector may be electrically conductive to conduct current generated at the anode. Electrically conductive anode current collectors or anode current collector inks may comprise a metal or metal alloy, including, but not limited to, Ag, Au, Ni, stainless steel, as well as carbon or any combination thereof.

In an embodiment of any of the sensors or methods as disclosed herein, the second current collector or cathode current collector may be electrically conductive to conduct current generated at the cathode. Electrically conductive cathode current collectors or cathode current collector inks may comprise a metal or metal alloy, including, but not limited to, Ag, stainless steel, Ni, Nickel mesh or any combination thereof.

In an embodiment of any of the sensors or methods as disclosed herein, the electrolyte may comprise, for example, potassium hydroxide, sodium chloride, lithium chloride, ammonium chloride, zinc chloride, zinc trifluoromethanesulfonate, zinc sulfate, water, dimethyl sulfoxide, a hydrogel, an organogel, or any combination thereof.

In an embodiment of any of the sensors or methods as disclosed herein, the separator may comprise, for example, polypropylene, glass fiber, hydrogel, paper, or any combination of these.

In an embodiment of any of the sensors or methods as disclosed herein, the ambient environment may comprise a sample gas.

In an embodiment of any of the sensors or methods as disclosed herein, the sensor may further comprise a housing. The housing may comprise one or more air inlets. Optionally, in an embodiment of any of the sensors or methods as disclosed herein, the one or more air inlets may comprise one or more holes. In an embodiment of any of the sensors or methods as disclosed herein, the one or more air inlets may be configured to control a rate of diffusion of a sample gas into the sensor to detect oxygen in the sample gas.

In an embodiment of any of the sensors or methods as disclosed herein, the housing may comprise a water-resistant material, for example, but not limited to, acrylonitrile styrene acrylate, a plastic material, or a metal material.

In an embodiment of any of the sensors or methods as disclosed herein, the sensor may comprise a gas diffusion membrane configured to control a rate of diffusion of oxygen from the sample to the cathode.

In an embodiment of any of the sensors or methods as disclosed herein, the gas diffusion membrane may comprise expanded polytetrafluoroethylene, nylon, neoprene, polytetrafluoroethylene, or a combination thereof.

In an embodiment of any of the sensors or methods disclosed herein, the one or more electrical signals may be indicative of the concentration of oxygen, for example, in a sample. The one or more electrical signals may comprise a voltage, a current, an impedance, an open circuit potential, or any combination thereof.

In an embodiment of any of the sensors or methods as disclosed herein, the anode and the cathode are operable to generate the one or more electrical signals indicative of the level of oxygen using amperometric detection, potentiometric detection, impedimetric detection, voltammetric detection or any combination of these.

In an embodiment of any of the sensors or methods as disclosed herein, amperometric detection may comprise applying a voltage bias across the anode and the cathode after delivering oxygen to the cathode and measuring a resulting output current indicative of oxygen concentration in a sample.

In an embodiment of any of the sensors or methods as disclosed herein the applied voltage may be greater than or equal to 0.5 V and less than or equal to 1.2 V. Optionally, the applied voltage may be greater than or equal to 0.55 V and less than or equal to 1.15 V. Optionally, the applied voltage may be greater than or equal to 0.6 V and less than or equal to 1.1 V. Optionally, the applied voltage may be greater than or equal to 0.65 V and less than or equal to 1.05 V. Optionally, the applied voltage may be greater than or equal to 0.7 V and less than or equal to 1.0 V. Optionally, the applied voltage may be greater than or equal to 0.75 V and less than or equal to 0.95 V. Optionally, the applied voltage may be greater than or equal to 0.8 V and less than or equal to 0.9 V. Optionally, the applied voltage may be about 0.85 V.

In an embodiment of any of the sensors or methods as disclosed herein, potentiometric detection may comprise measuring an open-circuit potential between the anode and the cathode, the open-circuit potential being indicative of oxygen concentration in the sample.

In an embodiment, the open circuit potential of the electrochemical oxygen sensor may be measured under no current flow. This is referred to as potentiometric detection and is based on the thermodynamic equilibrium of the electrochemical cell. The open circuit potential is given by equation FX1:

$${E}_{cell} = {E}^{0} - \frac{RT}{nF} ln ln ( \frac{1}{{p O}_{2}} ) ; \qquad ( FX1 )$$

wherein E⁰ is the cell potential under standard conditions and is given by equation FX2:

$${E}^{0} = {E}_{reduction}^{0} - {E}_{oxidation}^{0} ; \qquad ( FX2 )$$

wherein pO₂ is the partial pressure of oxygen; R is the universal gas constant; T is the temperature; n is the number of electrons; and F is faraday's constant.

In an embodiment of any of the sensors or methods as disclosed herein, impedimetric detection comprises applying a small-amplitude alternating voltage across the anode and the cathode measuring the resulting current response to determine an impedance of the sensor, the impedance being indicative of oxygen concentration in the sample.

In an embodiment, the alternating voltage may be sinusoidal, and the impedance may be determined as a ratio of the applied voltage to measured current as a function of frequency. Optionally, the applied voltage may be applied at a frequency of greater than or equal to 0.1 Hz and less than or equal to 1 MHz.

In an embodiment of any of the sensors or methods as disclosed herein, voltammetric detection may comprise sweeping a potential across the anode and the cathode over a voltage range and recording a resulting current response indicative of oxygen concentration in the sample.

In an embodiment of any of the sensors or methods as disclosed herein, the one or more electrical signals may be generated by short-circuiting the electrochemical sensor and measuring the recovery time of a cell potential.

In an embodiment of any of the sensors or methods as disclosed herein, the one or more electrical signals may be generated by applying a controlled current to the sensor and measuring a resulting potential between the anode and the cathode.

In an embodiment of any of the sensors or methods as disclosed herein, the method may further comprise comparing the measured one or more electrical signals with a calibration curve to determine the concentration of oxygen in the sample.

In an embodiment of any of the sensors or methods as disclosed herein, the sensor may comprise a housing and the housing may comprise one or more inlets. Optionally, in an embodiment, the housing comprises a water-tight housing.

In an embodiment of any of the sensors or methods as disclosed herein, the sample may comprise a soil sample and the providing a sample may comprise burying the sensor in the soil sample.

Further provided herein are devices and methods for fabricating a customizable electrochemical oxygen sensor based on zinc-air battery chemistry. The methods and devices disclosed herein offer a suite of electrochemical oxygen sensors for various applications and electrochemical sensing techniques ranging from amperometry to potentiometry. For example, customized sensors may be useful in an array of applications including but not limited to industrial manufacturing to track chemical processes or oxygen leaks, wildfire monitoring to track combustion reactions, medical applications to monitor patients' breathing, soil biogeochemical studies, air quality studies, monitoring car emissions, laboratory settings, and aerospace/astronaut safety.

In an embodiment of any of the sensors or methods as disclosed herein, the assembling the sensor may further comprise sealing the first substrate with the printed anode active layer, the second gas permeable substrate with the printed cathode active layer, and the separator together.

In an embodiment of any of the sensors or methods as disclosed herein, the sealing may be carried out using an airtight adhesive or tape, a pouch, plastic welding, coin cell packaging, or any combination thereof.

In an embodiment of any of the sensors or methods as disclosed herein, the pouch may comprise a gas permeable polymer to allow oxygen gas to enter the electrochemical oxygen sensor.

In an embodiment of any of the sensors or methods as disclosed herein, the printing may comprise depositing a material, for example and anode ink and/or a cathode ink via stencil printing, screen printing, thick-film printing, or any combination thereof.

In an embodiment of any of the sensors or methods as disclosed herein, the method of fabricating the sensor may further comprise annealing each of the first current collector layer, the printed anode active layer, the second current collector layer, and the printed cathode active layer at a temperature of greater than or equal to 25° C. and less than or equal to 160° C.

In an embodiment of any of the sensors or methods as disclosed herein, the thickness of each layer may be customized based on the desired application such that each of the first current collector layer, the printed anode active layer, the second current conductor layer, and the printed cathode active layer has a thickness of greater than or equal to 25 μm and less than or equal to 300 μm.

In an embodiment of any of the sensors or methods as disclosed herein, the method of fabricating the sensor further comprises first printed a first current collector material on an anode substrate, or a first substrate, thereby forming the first current collector layer, also referred to herein as the anode current collector layer.

In an embodiment of any of the sensors or methods as disclosed herein, the method of fabricating the sensor further comprises second printing a second current collector material on a cathode substrate, or a second substrate, thereby forming the second current collector layer, also referred to herein as the cathode current collector layer.

In an embodiment of any of the sensors or methods as disclosed herein, the cathode substrate may be permeable to oxygen.

### BRIEF DESCRIPTION OF THE DRAWINGS

FIG. 1: Components of a metal-air battery.

FIG. 2: The current is a function of reaction kinetics as governed by the Butler-Volmer equation (red and black). At highly negative overpotentials, the diffusion of oxygen becomes the rate limiting factor (pink).

FIG. 3A and FIG. 3B and FIG. 3C: Oxygen sensitivity of commercial zinc-air cells in Amperometric mode. FIG. 3A: current out by a commercially available zinc-air batter (ZAB) is a linear function of oxygen. FIG. 3B: current depends on the number of exposed holes of the housing. FIG. 3C: Current vs oxygen concentration for different over potentials during chronoamperometry.

FIG. 4A and FIG. 4B: Current measured for batteries in atmospheric oxygen (20.9%) and biased at 0.8V measured at different intervals for 1 month. FIG. 4A: lifetime of sensors measured intermittently over four months and FIG. 4B: Current vs measurement number.

FIG. 5: Schematic of using a single resistor to measure current. In this case, the cell potential will be linearly related to the current draw.

FIG. 6: Readout schematic for an amperometric measurement of ZAB using an op amp.

FIG. 7: Measured cell potentials vs oxygen concentration for one commercial ZAB over several days when measured with an Arduino® (colors) follow a Nernstian response with some fluctuations. A different commercial ZAB measured with a research-grade battery analyzer (black) showed a lower sensitivity. A theoretical Nernstian response E=1345+59 log O_{D}.

FIG. 8: The measured potential vs time for one month stability studies.

FIG. 9: Schematic showing a printed Zinc-air cell stack.

FIG. 10: Electrochemical cell fabrication. Individual electrodes are prepared via screen printing. The separator is soaked in electrolyte. The cell can be assembled by adhering the substrates of the cathode and anode directly to each other with the separator in the middle or by inserting the cathode-separator-anode stack into a sealable pouch.

FIG. 11: Amperometric characterization of zinc-air batteries over 24 hours as oxygen concentration increased from 0.2% to 16%. The standard deviation is represented by the shaded area (N=3).

FIG. 12: Potentiometric characterization of zinc-air batteries over 24 hours as oxygen concentration increased from 0.2% to 16% (N=1).

FIG. 13: Metal-Air Battery as Oxygen Sensor.

FIG. 14: Zinc-Air Battery Chemistry at standard conditions.

FIG. 15: Schematic showing exemplary printed Zinc-Air battery for oxygen sensing fabrication and the components of a printed zinc (or other metal)-air oxygen sensor.

FIGS. 16A-16C: Assembly steps of exemplary printed Zinc-Air battery for oxygen sensing.

FIG. 17: Amperometric sensing.

FIG. 18: Potentiometric mode.

FIG. 19: Exemplary embodiment of metal-air battery components.

FIG. 20A and FIG. 20B: Measured cell potentials vs. oxygen concentration for commercial zinc-air battery (ZAB) over several days. FIG. 20A: schematic for measuring a zinc-air battery in potentiometric mode. FIG. 20B: battery potential (voltage) as a function of oxygen concentration.

FIG. 21: Measured cell potential over several days for a commercial ZAB deployed in soil in a jar. Reference oxygen concentration is also shown.

FIG. 22: Measured cell potential over several days for a printed ZAB deployed in soil in a field. Reference oxygen concentration is also shown.

### DETAILED DESCRIPTION

In the following description, numerous specific details of the devices, device components and methods of the present invention are set forth in order to provide a thorough explanation of the precise nature of the invention. It will be apparent, however, to those of skill in the art that the invention can be practiced without these specific details.

In general, the terms and phrases used herein have their art-recognized meaning, which can be found by reference to standard texts, journal references and contexts known to those skilled in the art. The following definitions are provided to clarify their specific use in the context of the invention.

The term “electrochemical cell” refers to devices and/or device components that convert chemical energy into electrical energy or electrical energy into chemical energy.

Electrochemical cells may have two or more electrodes (e.g., positive and negative electrodes) and one or more electrolytes. For example, an electrolyte may be a fluid electrolyte or a solid electrolyte. Reactions occurring at the electrode, such as sorption and desorption of a chemical species or such as an oxidation or reduction reaction, contribute to charge transfer processes in the electrochemical cell. Electrochemical cells include, but are not limited to, primary (non-rechargeable) batteries and secondary (rechargeable) batteries. In certain embodiments, the term electrochemical cell includes zinc-air batteries, metal-air batteries, and catalysis or electrocatalytic cells.

The term “ionic communication” refers to the arrangement of two or more materials or items such that ions can be transported to, past, through, and/or from one material or item to another. Generally, ions can pass through ionically conducting materials such as ionically conducting liquids, such as water, or through solid ionic conductors. Preferably, but not necessarily exclusively, as used herein, transport or conduction of ions refers to transport or conduction of ions in an aqueous solution. For example, in some embodiments two materials or items are in ionic communication with one another if a path of ion flow is provided directly between the two materials or items. In some embodiments, two materials or items are in ionic communication with one another if an ion flow path is provided indirectly between the two materials or items, such as by including one or more other materials or items or ion flow paths between the two materials or items. In one embodiment, two materials or items are not necessarily in ionic communication with one another unless ions from the first material or item are drawn to, past and/or through the second material or item, such as along an ion flow path.

The terms “electrical couple,” “electrically coupled,” or “electrical communication” refer to the arrangement of two or more materials or items such that electrons can be transported to, past, through, and/or from one material or item to another. Electrical communication between two materials or items can be direct or indirect through another one or more materials or items such as an electronic unit. Generally, materials or items in electrical communication are electrically conducting or semiconducting.

The term “electronic unit” comprises all electrically operable circuit elements which are used for analyzing the signals and information of the electrochemical sensor and may comprise at least one device selected from the group consisting of: a voltage source, a current source, a voltage meter, a current meter, an impedance meter, an impedance spectrometer, a frequency analyzer, a potentiostat, a frequency generator, an operational amplifier, or a resistor.

The term “electrochemical measurement” refers to the measurement of at least one measurable characteristic of a redox reaction, e.g., one or more electrical signals. The electrochemical measurement and/or the measurable characteristic of the redox reaction, as an example, may imply an electrical current, a voltage, an electrical potential, a mass, for instance a mass deposited on an electrode, an impedance, particularly the real part and/or the imaginary part of the impedance, a capacitance, a resistance, or a phase shift. Specifically, the electrochemical measurement may be performed in the presence of an electroactive species.

The term “operable via the electronic unit to generate one or more electrical signals” refers to an electronic unit's ability to carry out an electrochemical measurement technique selected from the group consisting of: a cyclic voltammetry measurement; an impedance measurement; a potentiostatic measurement; an amperometric measurement; an electrochemical impedance spectroscopy measurement; voltammetry; amperometry; potentiometry; or coulometry. As used herein, the term “electrochemical impedance spectroscopy,” or more generally, “impedance” is used in accordance with its art-recognized meaning and may refer to the measurement of an impedance between the anode and the cathode as a function of a frequency of an electrical signal applied, such as a voltage and/or current. As further used herein, the term “voltammetry” is used in accordance with its art-recognized meaning and may refer to the measurement of the current between the anode and the cathode as a function of the voltage applied. As used herein, the term “amperometry” is used in accordance with its art-recognized meaning and may refer to the measurement of the current between an anode and a cathode, e.g., as a function of an applied voltage bias. As used herein, the term “potentiometry” is used in accordance with its art-recognized meaning and may generally refer to the measurement of the potential difference between the anode and the cathode under open-circuit conditions. As used herein, the term “coulometry” is used in accordance with its art-known meaning and may generally refer to the determination of the amount of charge produced or consumed during electrolysis. This may, for instance, be done by the measurement of a current between two electrodes, e.g., as a function of time.

The term “catalyst” used interchangeably with the term “electrocatalyst” refers to a catalyst that participates in or facilitates an electrochemical process or reaction. The term “electrocatalytic” refers to a material or item that is or is capable of being an electrocatalyst. For example, an electrocatalytic coating is a coating that is or is capable of being an electrocatalyst.

High temporal and high spatial resolution oxygen data is facilitated by low-cost and scalable oxygen sensors. However, current oxygen sensors are costly, use toxic materials, and are not easily scalable for mass production. As an alternative, sensors based on metal-air redox chemistry rely on more abundant and environmentally friendly materials than presently available galvanic oxygen sensors, and offer very low cost and low power oxygen monitoring. Depending on the application, commercial metal-air batteries or custom-made batteries may be applicable. Commercial metal-air batteries include, for example, presently available zinc-air hearing aid batteries. Custom-made fabricated electrochemical cells designed for improved sensitivity or robustness may be used for oxygen sensing applications with special requirements. Custom-made cells may have specific geometries, sizes, ratios of materials, or additional materials and layers that can tune the performance (lifetime, sensitivity, stability, etc.) of the oxygen sensors in a particular environment. Printing techniques may be used for scalable fabrication and the sensors can be read in a variety of ways. Measurements based on reaction kinetics and mass transport, e.g., amperometry, may provide fast response times while measurements based on thermodynamics, e.g., potentiometry, may offer very low detection limits.

Using a zinc-air battery as an oxygen sensor enables widespread deployment of oxygen sensing and integration with other sensors. One example where field deployable sensors are useful is in soil biogeochemical studies, where data is needed at high temporal and spatial resolution, including deployment at multiple depths. In this context, tens or thousands of sensors might be needed for a single study, so unit cost of a sensor becomes a driving factor.

Therefore, provided herein are low cost methods of oxygen sensing useful in any application, for example, where a large number of sensors is needed. Additional applications may include industrial manufacturing to track chemical processes or oxygen leaks, wildfire monitoring to track combustion reactions, medical applications to monitor patients' breathing, soil biogeochemical studies, air quality studies, monitoring car emissions, laboratory settings, and aerospace/astronaut safety. In each application, the zinc-air battery chemistry can be employed in different encapsulations and geometries customized to the application. Each embodiment may also use a particular, custom readout technique in order to meet the sensitivity, range, response time, and lifetime of the specific application.

Zinc-air batteries as oxygen sensors offer several advantages over existing galvanic and optical oxygen sensors. For example, zinc-air batteries are inexpensive—a battery may cost 10 cents or less, compared to $100 or more for oxygen sensors today. Zinc-air batteries are made of abundant, nontoxic, and biodegradable materials, namely zinc and carbon. Alternative galvanic oxygen sensors have been made from toxic materials such as lead, or rare materials such as bismuth/antimony alloys. Like any galvanic sensor, the sensor's signal is generated without an external power supply, unlike an optical probe which must be powered. Indeed, it may be possible to power the readout electronics with the sensor itself. Sensors in potentiometric mode may offer higher sensitivity at low oxygen concentrations than conventional oxygen sensors. One embodiment includes the use of existing zinc battery coin cells.

A second embodiment is to fabricate a custom zinc-air battery. In the case of custom fabrication, many variations are possible. For example, the specific amount of materials in the anode ink and the cathode ink may be varied to achieve a desired lifetime and stability. Gas diffusion membrane layers may be added or modified to increase lifetime and set sensitivity, control the maximum current, or increase or decrease the response time. Custom fabrication also enables specific geometry or form factors. For example, a wide, thin architecture may be desirable for ease of soil insertion and compatibility with other planar sensors. Oxygen selective membranes or encapsulations may be added to enable use in environments where commercially available zinc-air batteries are not suitable, for example, where high concentrations of CO₂ or water vapor are present, that would deteriorate the cell's performance and lifetime or where slim form factors enable ease of deployment, or where printing enables integration with other types of sensors. In addition, enclosing the zinc-air battery, for example a commercial zinc-air battery, behind membranes which may comprise a housing or with an active dehumidifier may also improve performance.

In a third embodiment, additional materials may be added for chemical or physical stability or ease of manufacturing. Anodic metals other than zinc, including but not limited to iron and aluminum, or alloys, may be used in place of or in addition to zinc. Solid electrolytes may be used for flexible applications or to improve robustness and sensing performance.

A fourth embodiment is a biodegradable version, wherein the housing, diffusion membranes, separator, current collector, and other parts may be made of biodegradable materials. Zinc itself is biodegradable in that it readily forms oxides and other naturally occurring compounds and is taken up by living things. In this embodiment, the sensors are deployed in the environment, for example, buried at different soil depths, and only the readout circuitry needs to be collected at the end of the deployment, eliminating any need to dig up the sensors again.

A fifth embodiment includes electronics which use the energy in the zinc cell to power the readout and data processing electronics. Essentially, this uses the zinc both as a battery and as a sensor. The sensors may be read in multiple ways. One way is to measure the output current at a controlled bias potential, also known as amperometric or galvanic readout. A second way is to measure the cell's open circuit potential, or potentiometric mode. A third way is to monitor the cell's impedance, also known as impedimetric mode. In an impedimetric mode, the controller applies a small-amplitude sinusoidal voltage to the cell and measures the resulting current response. The impedance is then calculated as the ratio of the voltage to the current, optionally as a function of frequency. A fourth way is to short circuit the cell and measure its recovery time. A fifth way is to draw a controlled current and measure the potential. Combinations of these techniques may also be used.

### Example 1: Commercial Batteries for Oxygen Sensing Background

High temporal and high spatial resolution oxygen data requires low-cost and scalable oxygen sensors. Historical oxygen sensors were galvanic cells that relied on lead (Pb) as the anode metal. Because of the toxicity of lead, modern galvanic O₂ sensors also use bismuth and its alloys. These commercial galvanic oxygen sensors have a lifetime of 2-10 years but cost a few hundred dollars each, severely limiting their scalability for collecting high temporal and high spatial resolution oxygen data.

The novel sensors disclosed herein are based on metal-air redox chemistry, employ abundant and environmentally friendly materials, and offer very low cost and low power oxygen monitoring. In a metal-air battery, thermodynamically favorable oxidation and reduction reactions that involve oxygen from the air generate electric power. In these devices the anode may be a metal (zinc, iron, aluminum) which is oxidized to form a metal oxide. The cathode is an inert electrode which provides a surface on which oxygen (O₂) from the air is reduced to OH.

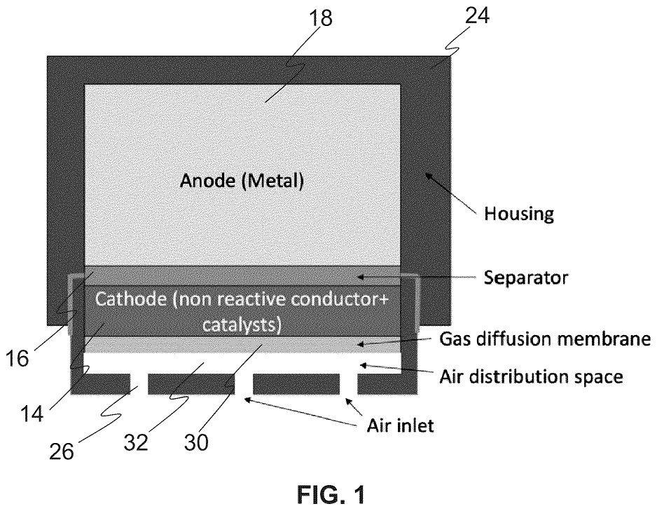

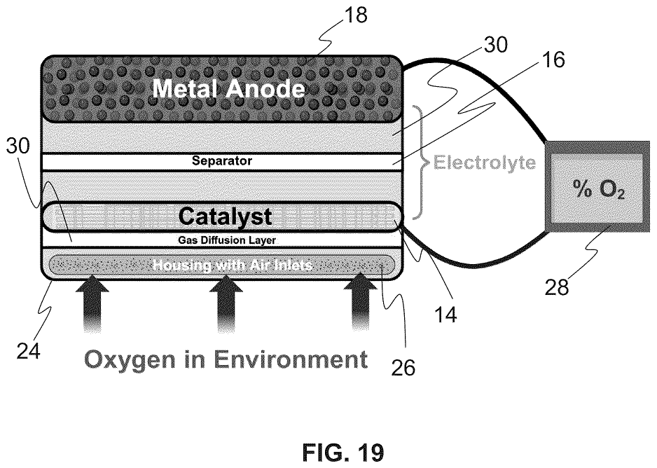

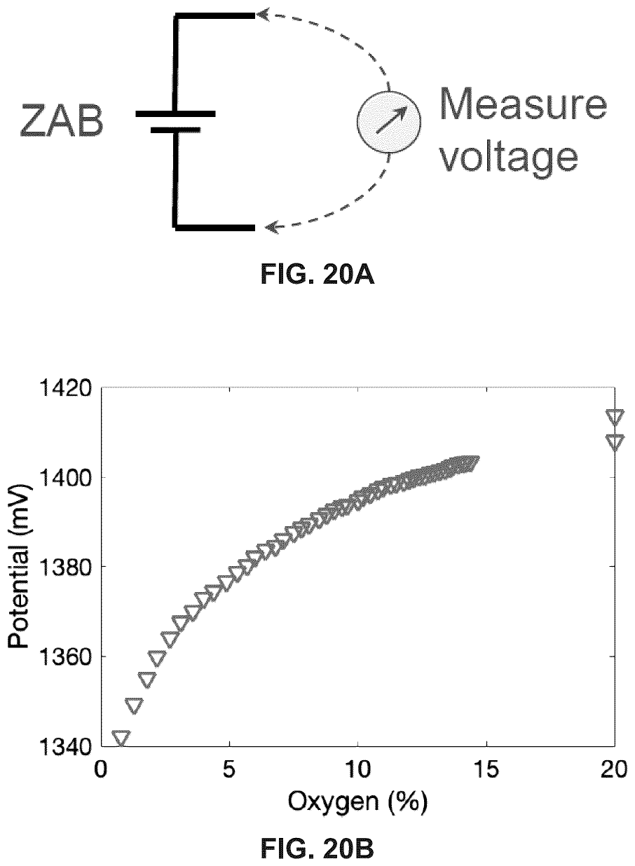

FIG. 1 depicts the components of a metal-air battery. Specifically, the components of a zinc-air battery may include a housing 24, an anode 18, a separator 16 which separates the anode 18 from the cathode 16 and establishes ionic communication between the anode 18 and the cathode 16, a cathode 16 comprising non-reactive electrical conductor and an oxygen reduction catalyst, a gas diffusion membrane 30, an air distribution space 32, and air inlets 26 which may be used to control the amount of sample air entering the housing. In another embodiment shown in FIG. 19, the assembly also includes an electronic unit 28 as described elsewhere herein. Due to the dependence of atmospheric oxygen on the electrochemical reactions of the battery, the cell's performance may correspond to the oxygen concentration. The concept of using commercially available zinc-air batteries as oxygen sensors has been presented as an exercise for high school students in the Journal of Chemical Education [1]. In this experiment, the batteries' leads were shorted, allowing a large current to flow, which consumes all the oxygen in the air distribution space and causes the voltage to plummet. The recovery time after shorting the battery is used as a “semiquantitative” measure of the oxygen concentration [1]. The readout circuit in this case consisted of an electronic sound box which required a minimum voltage to start playing, a switch, and the students using stopwatches to time the recharge. As the authors state, it is not a rigorous quantitative metric. Moreover, at oxygen concentrations below 20%, a single reading takes 10 minutes, and measurement time exponentially increases with dropping oxygen concentration. Nobuyoshi et al. have also explored commercially available zinc-air batteries as oxygen sensors as a low-cost experimental tool in schools [2]. There, the open circuit potential and discharge current were measured for commercial cells in plastic bags containing nitrogen and oxygen with known, varying oxygen concentrations. An expired patent (U.S. Pat. No. 5,902,467A, 1997) described using commercially available zinc-air batteries as oxygen sensors, but did not include fabrication of metal air cells for the specific purpose of oxygen sensing. The patent and the prior research studies have not demonstrated the viability of commercial batteries as oxygen sensors in non-standard environmental conditions with varying temperatures and humidities nor explored their suitability for sensors in extreme environments like soil, where fluctuations in moisture, pressure, and gas compositions arise from microbial and environmental activity.

### Example 2: Commercial Batteries Operated in Amperometric Mode

### Theory

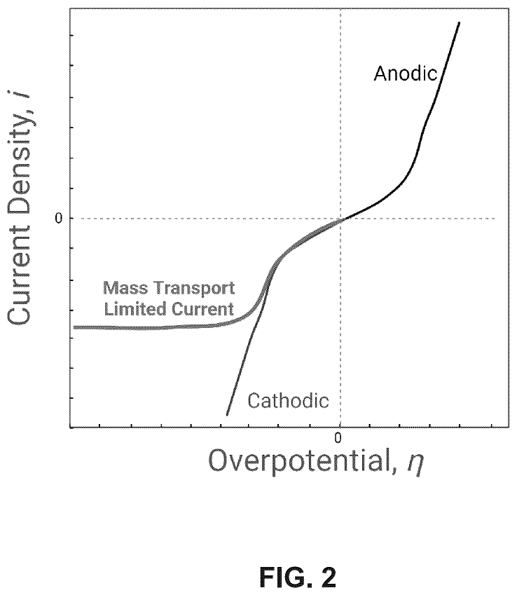

In a zinc-air battery, electrode kinetics and mass transport phenomena compete to determine the maximum current that can be discharged from a battery at a given potential. The amperometric mode measures this maximum current. The electrode kinetics may be expressed by Butler-Volmer kinetics, which state that the current due to the reaction at the electrode is exponentially related to overpotential, as shown by the black and red lines in FIG. 2. Overpotential is the difference between the equilibrium potential and the actual potential at an individual electrode. At sufficiently large overpotentials, the current may be limited by the rate at which reactants can arrive at the surface to react. This rate depends on mass transport phenomena within the cell due to (1) diffusion of oxygen gas through the air cathode, and (2) migration, diffusion, and convection of hydroxide ions through the aqueous electrolyte. The limiting current at sufficiently large overpotentials will be determined by the slowest mass transport phenomena as illustrated by the pink line in FIG. 2. In zinc-air batteries, the slow gas diffusion through the cathode determines the discharge current. The linear concentration gradient driving this diffusion results in a linear relationship between oxygen concentration and limiting current FX3:

$${i}_{limiting} = \frac{nF {D}_{{O}_{2}} {C}_{{O}_{2}}}{δ} \qquad ( FX3 )$$

where n is the number of electrons transferred, F is Faraday's constant (96,487 C/mol e−), D_{O2} is the diffusion coefficient of oxygen through the air cathode, C_{O2} is the concentration of oxygen outside the cell, and δ is the diffusion length of oxygen through the air cathode. The rate limiting current can be measured using chronoamperometry, where a highly negative overpotential is applied and the current is monitored over time.

### Sensitivity Measurements

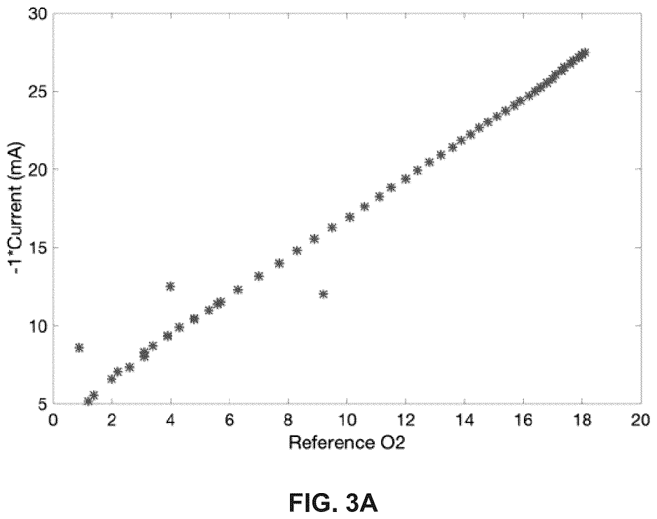

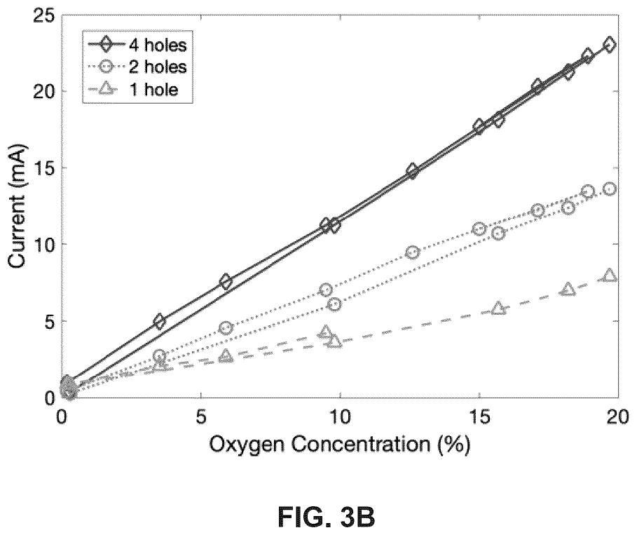

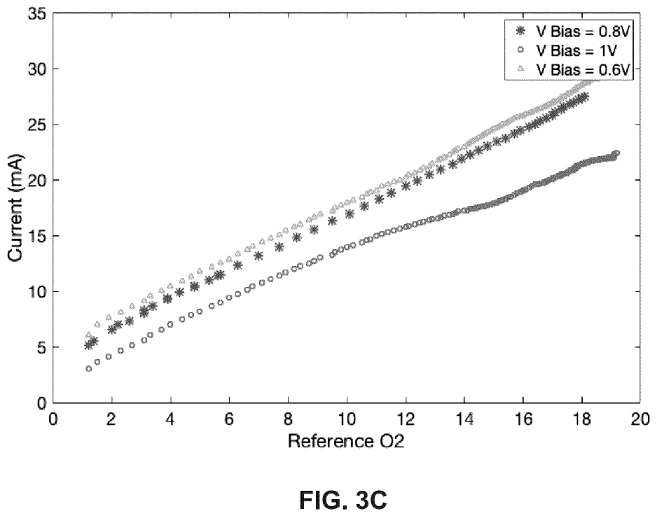

FIG. 3A shows the measured relationship between current and oxygen concentration for a commercially available 675 zinc-air battery biased at 0.8V (overpotential=0.8−1.4=−0.6V). The current is a linear function of oxygen diffusion, which is itself determined by the geometry of the cell and the diffusion membranes between the outside environment and the electrodes. Commercial batteries come with a sticky barrier covering the air access holes in order to extend their shelf life by preventing oxygen exposure. The barrier can be removed to expose between 1 and 5 holes. The more holes which are exposed, the higher the current for a given oxygen concentration, as shown in FIG. 3B. Notably, each configuration has a linear relationship between current and oxygen concentration, meaning that each of them are calibrated and work as a functional sensor.

The voltage used during chronoamperometry measurements also impacts the measured current, as shown in FIG. 3C. Using a larger overpotential (V_{BIAS}=+0.6V, η=−0.8V) increases the current draw, while using a smaller overpotential (V_{BIAS}=+1.0V, η=−0.4V), draws less current at the same oxygen concentration. The small overpotential case also is not linear throughout the full range of oxygen concentration, indicating that at high oxygen concentration, oxygen diffusion is not the rate limiting step.

### Field Deployable Readout Electronics

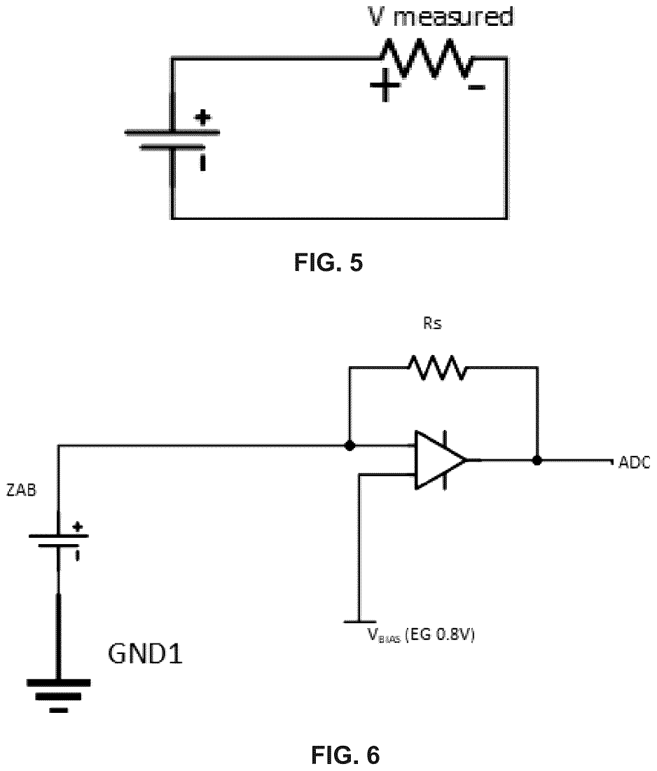

Amperometric sensors output a current, and many simple microcontroller based readout electronics measure input voltages. The simplest way to convert a current to a voltage is to run the current through a small resistor, then measure the resistor's voltage, as illustrated in FIG. 5. However, if the current is discharged through a resistor only, then the potential of the cell depends on the current draw, and the measured current at high oxygen is lower than would otherwise be expected. Another way to measure current is to use a transimpedance amplifier for example shown in FIG. 6. In this case, the ZAB's voltage is kept constant regardless of current draw, and the voltage measured at the op amp's output is a function of ZAB current.

### Lifetime and Stability Measurements

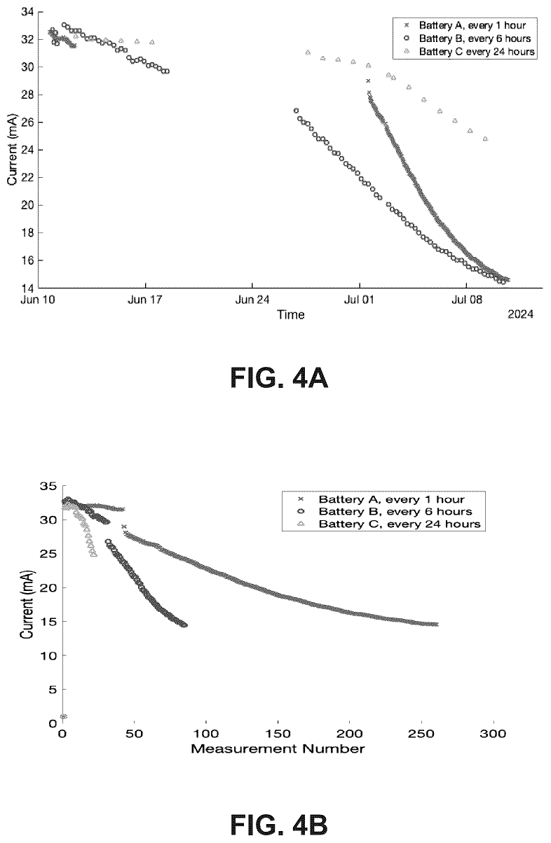

The measured current depends not only on the oxygen concentration, the overpotential and the diffusion pathways for oxygen, but also on age of the battery, and how it is measured. Continuous readings can be obtained by running continuous current through the readout circuit. In this case, the lifetime is limited by the discharge current over time, and the capacity of the battery, which is about 600-650 mAh for a commercial 675 ZAB. For commercial batteries with 2 or more holes exposed and without an additional diffusion membrane, continuous operating lifetime can be as short as 40 hours under atmospheric oxygen concentration (see FIG. 4A), or longer than 540 hours under low oxygen (<4% O₂). Installing the battery in a housing with a gas diffusion membrane limits the current and extends the lifetime.

Some applications require sensor lifetimes on the order of weeks or months but do not need high frequency data. In these cases, intermittent measurement can be used. In this set up, the measuring circuit is normally off, and turns on for a few minutes every few hours or days . . . . In this approach, there is an initial large spike of current as built-up OH is oxidized, and stable currents are reached once the system becomes oxygen-diffusion-limited.

As ZABs are exposed to air, some chemical degradation occurs, which reduces the current of the ZAB, even if the cell was kept in open circuit (zero current flow) conditions. Additionally, every time a measurement is taken, some current flows, which converts Zn to ZnO, which reduces the maximum current of the next measurement. FIG. 4A shows the current measured over 1 month for cells measured once every 1 hr, 6 hrs, or 24 hrs. The current drops most quickly over time in the cell that was measured every 1 hr because the Zn is consumed. However, the current dropped most quickly vs measurement number in the cell which was measured every 24 hrs because of the aging that occurred between each measurement. Under low oxygen concentration, chemical aging and Zn oxidation both occur more slowly. For a ZAB that experienced several oxygen concentration swings, and which was measured every 15 minutes, the battery's current at 2% oxygen had decreased by 8% over two weeks. This change in current over time requires calibration or post-measurement data correction.

### Temperature and Humidity Dependence

Results show that the measured current increases as temperature increases and that the response time for a temperature change is less than 5 minutes. Therefore oxygen sensors are paired with a temperature sensor for calibration, which is common for commercial oxygen sensors today.

### Gas Diffusion Membranes and Humidity Controlled Enclosure

To protect the sensor from changes in humidity, it may be placed in a watertight container with an oxygen-permeable membrane covering an opening. The container may be 3D printed ASA treated with acetone to seal cracks. It could alternatively be made of other water-impermeable materials including other plastics or metal. Possible gas diffusion membranes include Gor-tex®, other fabrics involving expanded polytetrafluoroethylenes, nylon, neoprene, and non-expanded PTFE (Teflon). These membranes also reduce the oxygen diffusion rate which slows sensor response time but increases sensor lifetime. Additionally, an active dehumidifier can be incorporated in the housing to reduce humidity fluctuations.

### In-Soil Data

A watertight airspace was created from a piece of PVC pipe and gore-tex® fabric. A commercial oxygen sensor (Apogee Instruments, USA) is placed inside the tube, with the tube epoxied to the sensor to prevent water ingress. The ZAB is also placed inside the tube, with connecting wires leading out of the tube. Gore-tex® fabric and watertight tape are used to seal the volume. The entire assembly is then buried in samples of agricultural peat soil from Bouldin Island in the Sacramento-San Joaquin Delta, California. The soil is saturated with water and placed in an airtight mason jar. Once the soil is wetted, the microbial activity in the soil consumes oxygen, so the oxygen concentration inside the sealed jar decreases.

### Example 3: Commercial Battery in Potentiometric Mode

Use of a zinc-air cell to measure oxygen in a potentiometric mode is also possible. In this mode, the open circuit voltage or potential of the cell is monitored, and this potential depends on the oxygen concentration according to the Nernst equation.

### Theory

The cell potential under standard conditions E⁰ is given by equation FX1:

$${E}_{cell} = {E}^{0} - \frac{RT}{nF} ln ln ( \frac{1}{p {O}_{2}} ) ; \qquad ( FX1 )$$

wherein E⁰ is the cell potential under standard conditions and is given by equation FX2:

$${E}^{0} = {E}_{reduction}^{0} - {E}_{oxidation}^{0} ; \qquad ( FX2 )$$

wherein pO₂ is the partial pressure of oxygen; R is the universal gas constant; T is the temperature; n is the number of electrons; and F is faraday's constant.

### Sensitivity Measurements

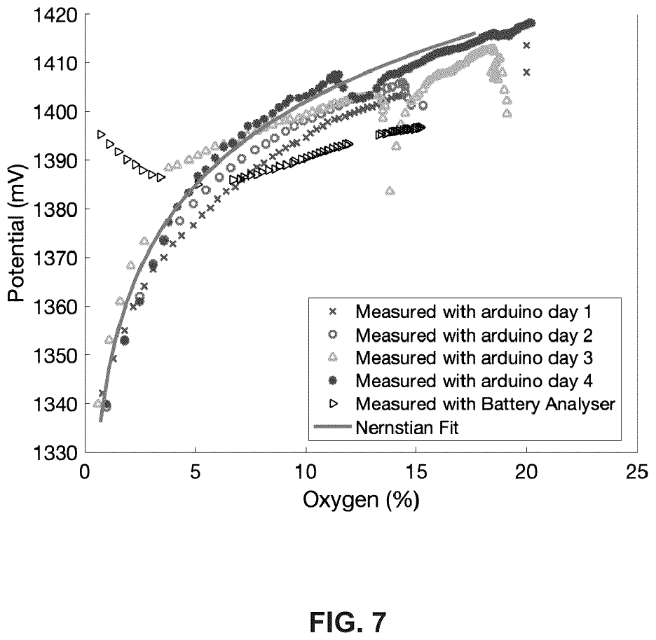

To measure sensitivity in potentiometric mode, the ZAB is placed in a container with controlled and known oxygen concentration, and the potential difference (voltage) between the anode and cathode is measured with no current flowing. This may be done with a battery analyzer, potentiostat, or simply the voltage inputs of a microcontroller. The measured potential vs oxygen concentration is shown in FIG. 7. In this study, one ZAB is measured with an Arduino® Mega over several days. Each day the oxygen concentration started low (<1%) and slowly increased over the day. Some fluctuations were observed on days 3 and 4 which may be due to temperature variations on those days. A similar ZAB was measured with a battery analyzer (Biologic®), and this data is shown as black triangles in FIG. 7. The response time for the battery measured this way was considerably slower for the cell measured on the BioLogic® than the Arduino®. The measured potential was high for low oxygen concentrations because the ZAB took several hours to reach a low potential.

The sensitivity of the ZAB-as-oxygen-sensors was measured potentiometrically over multiple days as oxygen concentration was increasing. In potentiometric mode, the ZABs display high sensitivity at very low oxygen concentration and lower sensitivity at high oxygen concentration. They can take several hours to respond to a change in oxygen, as shown in FIG. 7.

### Lifetime

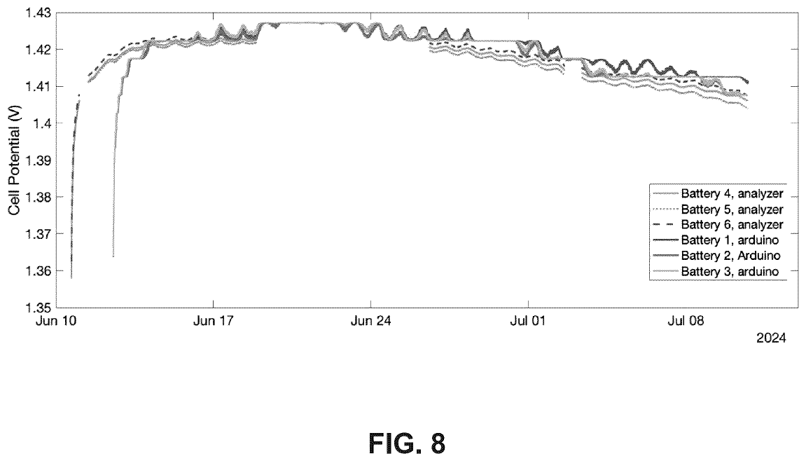

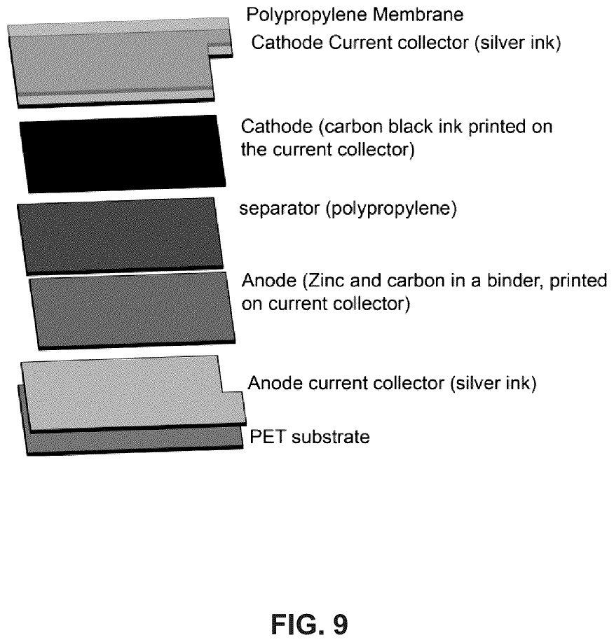

In potentiometric mode, commercial 675 Zinc-air batteries remain operational for a month under ambient oxygen conditions with continuous measurement. The signal in potentiometric mode drifts over time and recalibration approximately every week may be needed for accurate data. The lifetime of the ZAB-as-oxygen-sensors was measured by constantly monitoring their potential over one month., as shown in FIG. 8. Three cells were monitored with the BioLogic® battery analyzer and three other cells were monitored with the Arduino® Mega. All cells were kept in ambient conditions (oxygen 20.9%, temperature not finely controlled.)

### Temperature Dependence

The potentiometric mode is temperature dependent. Results show that the response time for changes in temperature is more than 1 hour. An increase in temperature leads to a decrease in measured potential, as expected by the Nernst equation.

### In-Soil Data

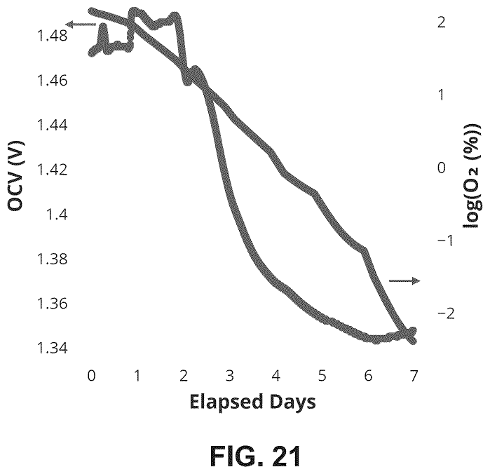

Data in soil is gathered using the same test set up as described in the amperometric section. To collect this data, a watertight airspace was created from a piece of PVC pipe and gore-tex® fabric. A commercial oxygen sensor (Apogee Instruments, USA) was placed inside the tube, with the tube epoxied to the sensor to prevent water ingress. The ZAB is also placed inside the tube, with connecting wires leading out of the tube. Gore-tex® fabric and watertight tape were used to seal the volume. The entire assembly was then buried in samples of agricultural peat soil from Bouldin Island in the Sacramento-San Joaquin Delta, California. The soil is saturated with water and placed in an airtight mason jar. Once the soil is wetted, the microbial activity in the soil consumes oxygen, so the oxygen concentration inside the sealed jar decreases. The commercial ZAB cell potentials were measured when the cells were placed in a water-tight housing and buried in real soil samples. The data shows cell potential decreasing at first as oxygen concentration decreased (FIG. 21). At very low oxygen concentration, cell potentials were unstable, which may be due to changes in pressure, temperature, or high concentrations of interfering gasses produced by the microbes such as carbon dioxide or methane.

### Comparison of Measurement Techniques

Both sensing modes have advantages and disadvantages. Which mode to choose depends on the specifics of the application. Advantages of Amperometric Mode include a linear response, large signal, relatively small drift over time, and a quick response time. Advantages of Potentiometric Mode include longer lifetimes because of the minimal current passed wherein taking a measurement does not alter the battery, and high sensitivity at low concentrations. However, some drawbacks to potentiometric mode include a relatively small signal and a relatively large drift over time being possible.

### Example 4: Printed Zinc-Air Cells

The first primary (non-rechargeable) zinc-air battery entered the market in the 1960s, enabled by the developments of powdered zinc electrodes and air electrodes based on waterproof PTFE films. In recent decades, research has shifted towards rechargeable zinc-air batteries. However, a rechargeable zinc-air battery has yet to enter the market due to technical challenges with dendrite formation, hydrogen evolution, and creating an air cathode that can efficiently catalyze both oxygen reduction reaction and oxygen evolution reaction in alkaline environments.

Printed zinc-air batteries were developed in the early 2000's. Recent developments in printed zinc-air batteries focus on material improvements to one electrode or the other and highlight the impact on capacity, voltage, or lifetime as a result.

### The Anode

The anode is the supply of zinc for the electrochemical reaction. Applicable anodes minimize side reactions, provide high surface area for zinc to react with the ions in the electrolyte, and provide paths for current to reach the current collector. Cell failure may arise from passivation of the zinc, dendrite formation, or hydrogen evolution on the anode. Passivation of the zinc, in which zinc oxide and zinc hydroxide sediments cover the anode's surface, preventing further reactions, reduces the theoretical energy density of 1000 Wh/kg to an actual energy density of 300 Wh/kg. The simplest approach to mitigating passivation is increasing electrolyte concentration, as the passivation layer is not as stable at higher pHs. However, high salt concentrations can increase the rate of corrosion of the zinc, so an optimum salt concentration must balance these concerns. Surfactants may also prevent passivation by making the sediments more porous, which allows ions, for example hydroxide ions, to still pass through and react with the zinc. To prevent dendrite formation, ion exchange coatings on the anode can also permit hydroxide and water to react with the zinc but prevent zinc products from exiting and forming precipitates far from the surface, which would turn into dendrites. Organic or inorganic additives may also be included in the electrode and electrolyte, which change the deposition behavior of the precipitates.

Hydrogen evolution may be inhibited by organic or inorganic additives because they change the evolution potential or form an adsorption layer around the anode that prevents the hydrogen evolution reaction from occurring.

Hilder et al 2009 used a mixture of zinc and carbon—for improved conductivity—with a polycarbonate binder and THF solvent [3]. In 2012, the same group replaced the polycarbonate binder with sodium silicate for improved stability [4]. Suren and Kheawhom 2016 used 69.3% zinc, 7.3% ZnO, 10.9% Bi203, 1.6% styrene butadiene, and 10.9% toluene solvent [5].

### The Cathode

The cathode may provide a site for oxygen to be reduced, catalyzing the oxygen reduction reaction, and transports electrons from the current collector. The oxygen reduction reaction requires the overcoming of a large thermodynamic barrier. Catalysts with optimum adsorption/desorption sites for products in the multiple electron transfer enable faster kinetics of the reaction, which leads to low overpotentials and thus higher open circuit potentials. Noble metals, transition metals, metal oxides/calcites/carbides/nitrides, carbon materials, and composites have been explored as catalysts for the oxygen reduction reaction in varying pHs. For primary alkaline zinc-air batteries, carbon-based catalysts are often selected for their low cost, good conductivity, and stability in an alkaline environment during the discharge of the battery. According to Wang, a commonly used cathode, which consists of the catalyst and a gas diffusion layer, which allows gasses to diffuse across the entire catalyst, is carbon powder pressed into a nickel mesh current collector, held in place by a binder [6]. A hydrophobic additive is used on the air-facing side to keep the pores open for the air to come in but prevent moisture from entering the cell. The gas diffusion layer also supports thin catalysts, which are attractive for their lower resistive losses. The thickness of the air cathode may also determine the discharge current, as the tortuous path of oxygen through the cathode establishes the concentration gradient. The shorter the path, the higher the concentration gradient and thus the higher the current able to be discharged.

Wang et al used single walled carbon nanotubes “decorated” with silver nanoparticles (AgNP) [6]. The AgNPs catalyze the oxygen reduction, while the nanotubes provide good conductivity. Suren and Kheawhom compared carbon paper with carbon black ink printed directly on the silver current collector [5]. They found that the carbon black ink had slightly higher voltage and longer life than the carbon paper when discharging across a resistor. This group also compared cathode current collectors made of a stainless steel mesh to silver printed on polypropylene, and found that the printed silver had higher voltage for all currents than the steel mesh.

### The Electrolyte

The electrolyte transports OH— and other species involved in reactions between the anode and the cathode, while ideally not reacting with the zinc. A conventional electrolyte is concentrated KOH, which, as a strong base, makes the oxygen reduction to OH-more favorable than other oxygen reduction reactions, and provides OH— groups for the zinc to react with. However, water based electrolytes like KOH solution can react with zinc, using up the zinc without generating any electricity, which causes the battery to have a shorter life and less power output. KOH and water can also react with carbon dioxide that enters the cell to form potassium carbonate precipitates, which may clog pores in the air cathode and deteriorate battery performance and lifetime. Non-alkaline liquid electrolytes may also be useful, as slightly acidic solutions minimize the carbonation reaction and are also more affordable. Aqueous ammonium chloride is often used as a near-neutral or slightly acidic electrolyte for zinc-air batteries. Hilder in 2009 compared efficiencies of batteries whose anodes were made of 20-80% zinc in carbon using NaCl and LiCl electrolytes [3]. They found that for high zinc content, efficiency was much higher in LiCl electrolytes, and attributed this to the higher concentration of LiCl and higher affinity of water for LiCl, which meant less water is available to react with the zinc. Sun et al. also explored Zinc trifluoromethanesulfonate as an electrolyte salt and found it to facilitate the 2 e-oxygen reduction pathway, rather than the 4 e-oxygen reduction pathway [10]. As such, no hydroxide ions were formed, and, as no hydroxide ions were present to begin with, the cell is resistant to degradation from undesired reactions with carbon dioxide that may enter the cell. For such non-alkaline systems, the working voltage and discharge current density is not as high as in alkaline systems.

Polymer-based electrolytes have also been explored to form flexible zinc-air batteries, prevent leaching of electrolyte into the environment, and decrease zinc corrosion rate. KOH mixed into polyvinyl alcohol is a common polymer electrolyte for zinc-air batteries [7-9]. A further advantage of solid electrolytes is that their viscosities are much higher than aqueous electrolyte, thus lowering the diffusion of carbon dioxide or other gasses that can be involved in undesired side reactions. However, solid polymer electrolytes introduce more resistance in the cell due to lower ionic conductivity, which may hinder their performance.

### Printed Batteries

Initial printed batteries are made with screen printed silver ink for both current collectors, zinc ink made with polycaprolactone binder and anisole solvent for the anode, and screen printed carbon for the cathode. PET was used as the substrate for the anode, while polypropylene or polytetrafluoroethylene was used for the cathode substrate. The separator may be a commercially available grafted non-woven polypropylene separator for alkaline electrolytes or a glass fiber separator for non-alkaline electrolytes where the glass will not corrode

### Fabrication

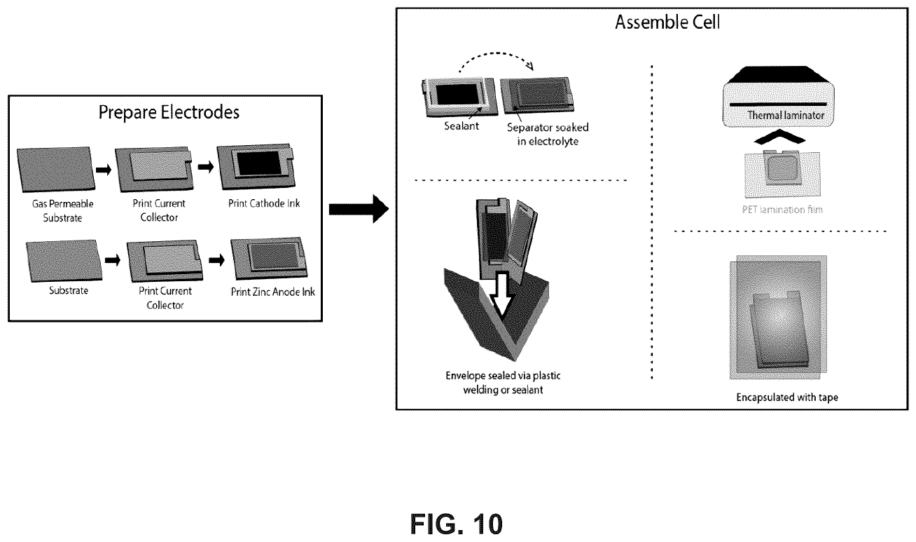

Fabrication steps are illustrated in FIG. 10 according to an embodiment. Current collector, anode, and cathode layers were screen printed. Current collectors are screen printed using silver ink. Anode current collectors are printed on PET. Cathode current collectors are printed on polypropylene. All current collectors are annealed on a hot plate set at 140° C. for at least 10 minutes. The anode zinc ink is homemade 30:1:8 Zn: PCL: Anisole by mass. The carbon is printed using commercially available carbon ink. Each layer is, for example, between 50-100 micrometers thick. The printed electrodes are also made with, for example, stencil printing or other thick film printing techniques.

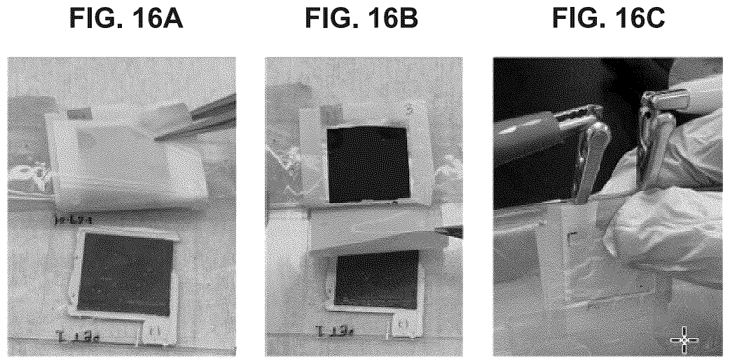

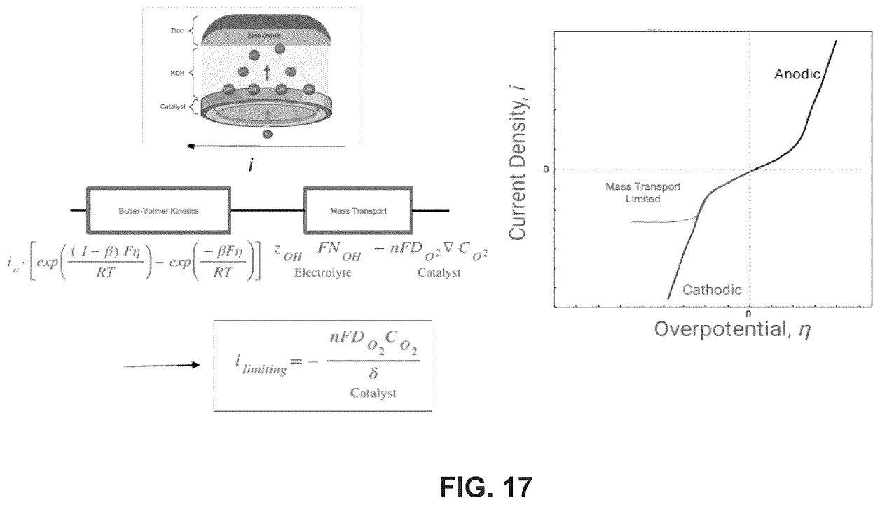

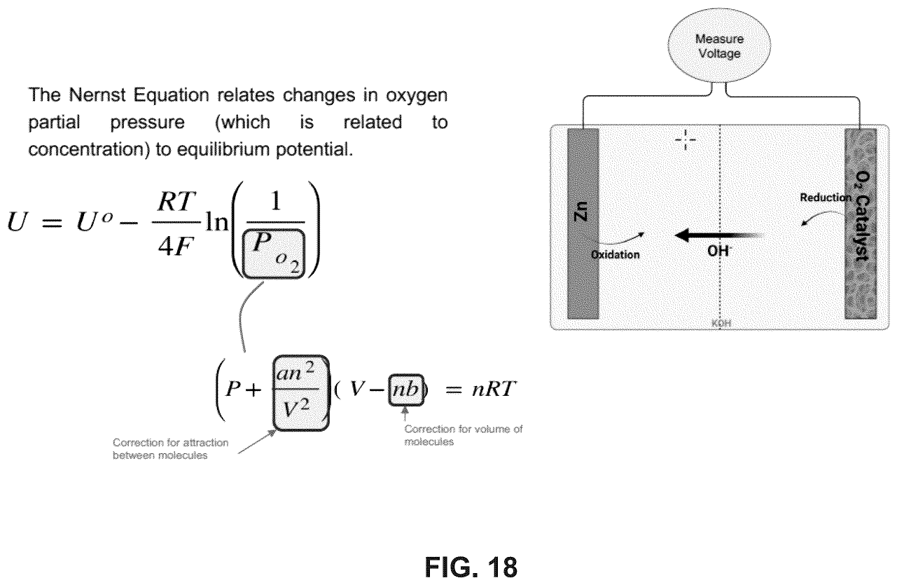

After the current collector, anode, and cathode inks are cured, the cell is assembled. In one technique, Torr Seal, an airtight adhesive, is used to glue the layers together. The Torr Seal is applied in a ring around the current collector on the substrate of one electrode (for example, the cathode) then the separator soaked in electrolyte is placed on the cathode, and finally the anode is placed face down on the separator as shown in FIGS. 16A-16C. The Torr Seal bonds the edges of the anode substrate to the edges of the cathode substrate. In a second technique, the same sandwich—cathode-separator-anode—is made and the edges of the cathode and anode substrates are held together with tape. A third assembly style involved a pouch to hold the electrodes, separator, and electrolyte as shown in FIG. 16C. The pouch is made of an air permeable polymer such as polypropylene. Its edges can be sealed shut by heat sealing, also known as plastic welding. Alternatively, the pouch edges are sealed with a chemical adhesive like Torr Seal. The device may also be encapsulated with expanded polytetrafluoroethylene tape.

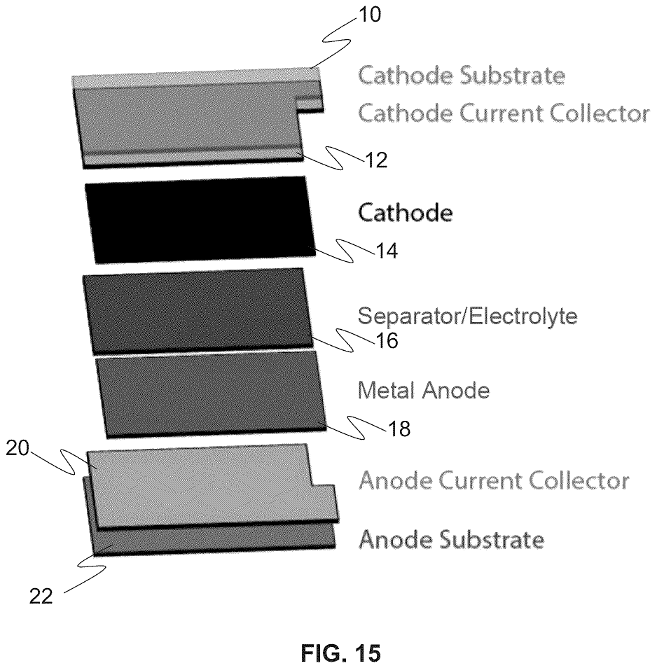

The components of an exemplary printed electrochemical sensor are illustrated in FIG. 15. In this embodiment, shown is the cathode substrate 10 on which a cathode current collector or otherwise referred to herein as a second current collector 12 is printed. The cathode active layer 12 is provided as a cathode ink printed on the second current collector 12. Next, the separator 16, optionally comprising an electrolyte, is disposed between the cathode active layer 12 and the anode active layer 18. The anode active layer 18, optionally a metal anode, is provided as a printed ink on the anode current collector, also referred to elsewhere herein as the first current collector 20. The first current collector 20 is optionally provided as a printed anode current collector ink on the anode substrate 22 and the second current collector 12 is optionally provided as a printed cathode current collector ink the cathode substrate

Although these batteries were made with a specific set of inks, substrates, adhesives, and additives, a host of other combinations may be used. TABLE 1 is a non-exhaustive list of materials which may be used in various embodiments.

TABLE 1

| Role | Materials |
|---|---|
| Anode Substrate | Polyethylene terephthalate |
| | Polyethylene naphthalate |
| | Polytetrafluoroethylene |
| | Polyimide Film (Trade Name: Kapton) |
| | Other plastics |
| | Glass |
| Anode Current | Silver |
| Collector | Gold |
| | Stainless Steel Mesh |
| | Carbon |
| | Other metals |
| Alternative Anode | Magnesium |
| (active layer) | Lithium |
| Materials | Aluminum |
| | Iron |
| | Sodium |
| Anode Additives | Zinc oxide |
| | Carbon (carbon black, CNTs, |
| | graphene powder, etc) |
| | Bi₂O₃ |
| | Styrene Butadiene |
| | Sodium silicate |
| | Polycarbonate |
| | Polyethylene glycol |
| | Conductivity treatment for zinc |
| | (acid sinter or photonic sinter) |
| | Magnesium |
| | Aluminum |
| | Lead |
| | Indium |
| Cathode Substrate | Polypropylene |
| | Polytetrafluoroethylene |
| | Other gas permeable plastic |
| | Paper |
| Cathode Current | Silver |
| Collector | Stainless steel mesh |
| | Nickel mesh |
| Cathode (active | Commercial carbon inks |
| layer) | Custom carbon black/graphite ink blends |
| | Carbon paper |
| | Carbon nanotubes |
| | Silver nanoparticles |
| | Perovskites |
| | Polytetrafluoroethylene |
| | Noble metals |
| | Transition metals |
| | Metal oxides |
| | Metal calcites |
| | Metal carbides |
| | Metal nitrides |
| Electrolyte | KOH |
| | NaCl |
| | LiCI |
| | Ammonium chloride |
| | Zinc chloride |
| | Zinc trifluoromethanesulfonate |
| | Any of the above held in a hydrogel |
| | or oranogel (PVA, acrylamide, etc.) |
| Electrolyte | Sodium citrate |
| Additives | Sodium stannate |
| | Calcium oxide |
| Separator | Polypropylene |
| | Glass Fiber |
| | Paper |
| Binder for cathode, | Polycaprolactone |
| anode, or current | Polyvinylpyrrolidone |
| collector inks | Polyvinyl alcohol |
| | Polyvinyl acetate |
| | Polytetrafluoroethylene |
| | Polyvinylidene fluoride |
| | Pyridine-styrene-butadiene rubber |
| | Poly(3-hydroxybutyrate-co-3- |
| | hydroxyvalerate) |
| | Soy, candelilla, or bees waxes |
| | Other polymers |
| | Other natural materials |
| Solvent for cathode, | Anisole |
| anode, or current | Tetrahydrofuran |
| collector inks | N-Methyl-2-Pyrrolidone |
| | Acetone |
| | Isopropanol |
| | Water |

Amperometric Sensor Data from Printed Cells

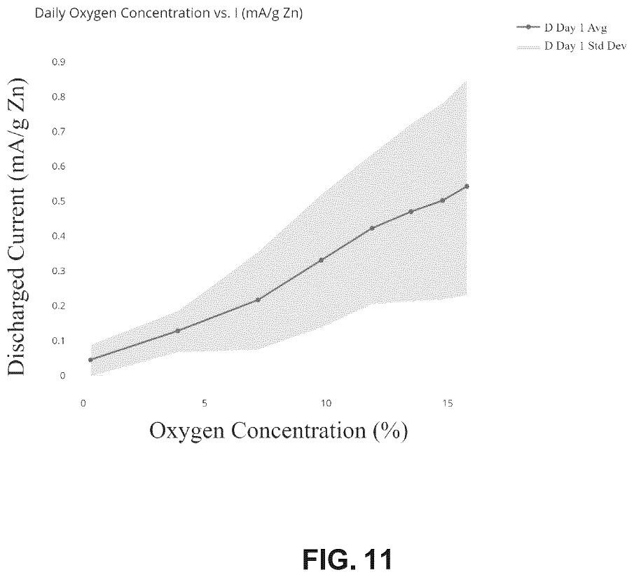

Printed cells were characterized using amperometry. There was a linear relationship between oxygen and current. Lifetimes up to 72 hours have been achieved. Further optimization can increase lifetime and reduce sensor-to-sensor variability. Amperometric characterization of cells is conducted over 24 hours as oxygen concentration varied from 0.2% to 16% and is presented in FIG. 11. The amperometric mode follows a linear relationship between concentration and discharged current, as expected. There is more variation at higher oxygen concentrations near 15% oxygen. The sensitivity at higher oxygen concentrations may be improved, for example, through materials selection and cell design optimization. For instance, a thinner air cathode will result in larger limiting currents, as described by Equation FX3, which may improve sensitivity of the device. Further studies indicated that the cells lasted up to 72 hours and were capable of specific capacities of 2 mAh/g Zn. The lifetime and capacity may be improved, for example, through materials selection and cell design optimization, in which encapsulants and additives provide protection from the external environment or reduce internal resistances.

Potentiometric Data from Printed Cells

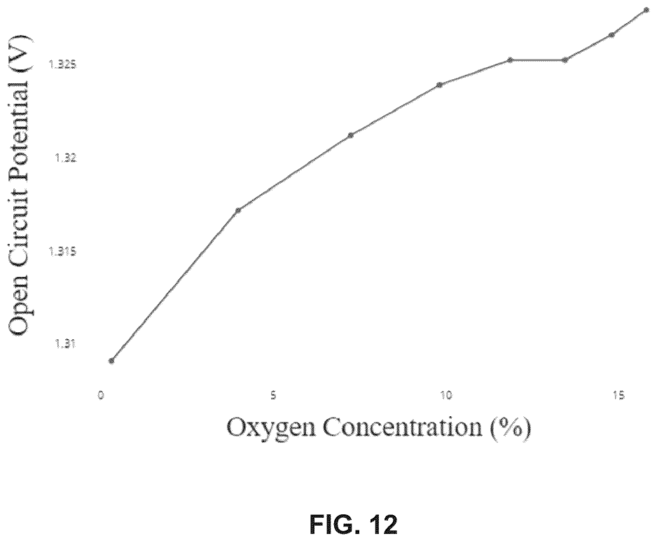

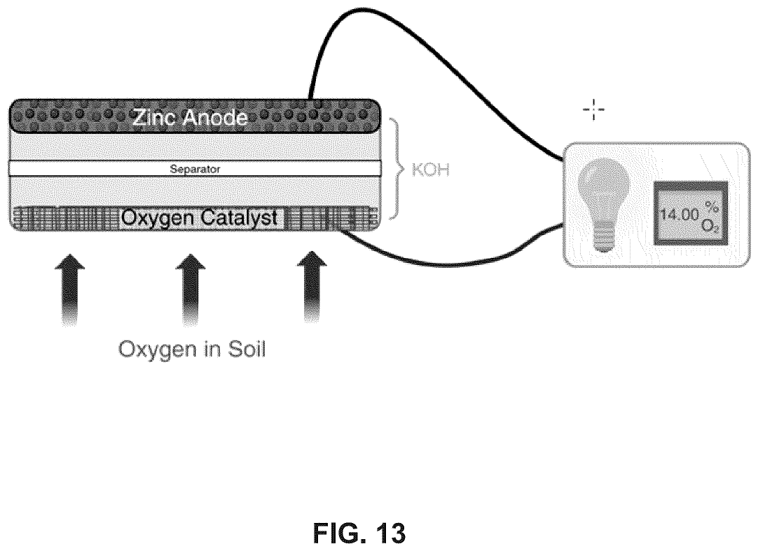

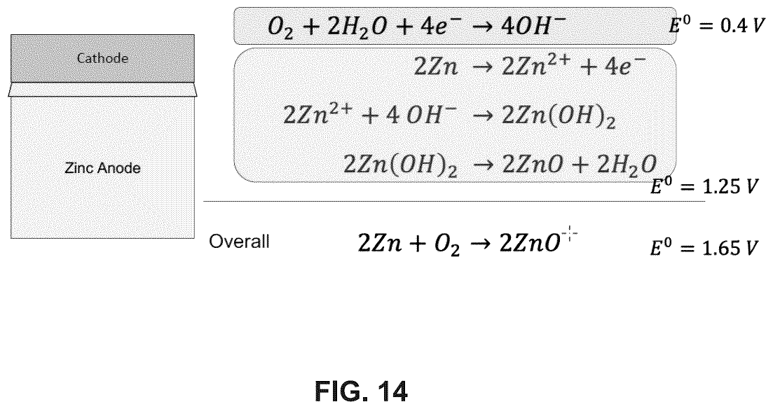

The potentiometric characterization follows a logarithmic relationship between concentration and open circuit potential at lower concentrations, as expected, but fluctuations in temperature, the presence of other gasses, and drift over time can negatively impact devices as shown in FIG. 12.

In-soil Data from Printed Cells

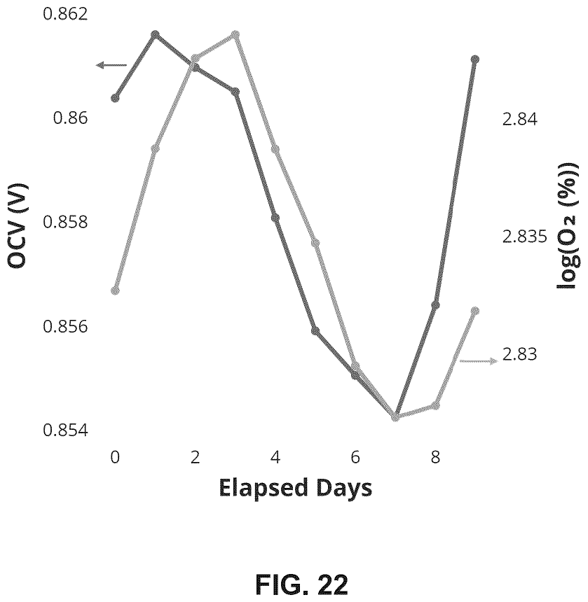

To collect data in soil, a small watertight airspace was constructed using a plastic container in which one side was replaced with Gore-Tex® fabric and sealed using outdoor duct tape. Inside this enclosure, the zinc-air-battery sensor, consisting of a zinc foil anode welded to a nickel tab, a glass-fiber separator saturated with 1 M Zn(OTf)₂, and a carbon/PTFE printed cathode on a carbon-paper substrate in contact with a nickel mesh current collector, was connected to the data-acquisition system through flex-pin cable connectors and cabling that passed through the sealed housing. The entire assembly was then buried approximately one foot deep into agricultural soil in Bouldin Island in the Sacramento-San Joaquin Delta, California for over a week. A commercial ground-truth oxygen sensor installed nearby provided ground-truth oxygen concentrations in the environment. The potential of the zinc-air battery corresponded to changes in the ground-truth oxygen concentrations as presented in FIG. 22.

Zinc-air batteries offer a promising means of very low cost and low power oxygen sensing. Various electrochemical readout schemes, for example, amperometric and potentiometry are useful, and have different advantages and disadvantages. The use of commercially available zinc-air batteries as oxygen sensors enables rapid and scalable oxygen sensor deployment. Custom zinc-air cells with layers tuned for sensor performance allow mass manufacture of oxygen sensors with improved sensitivity, lifetime, and stability.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the disclosed subject matter (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate the disclosed subject matter and does not pose a limitation on the scope of the invention unless otherwise claimed. No language in the specification should be construed as indicating any non-claimed element as essential to the practice of the invention.

Certain embodiments are described herein. Variations of those embodiments may become apparent to those of ordinary skill in the art upon reading the foregoing description. The inventors expect skilled artisans to employ such variations as appropriate, and the inventors intend for the embodiments to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

### REFERENCES

1. Hooi, Y. K., Nakano, M. & Koga, N. A Simple Oxygen Detector Using Zinc-Air Battery. J. Chem. Educ. 91, 297-299 (2014).
2. Yuu, T. & Koga, N. A Convenient Measurement of Oxygen Concentration using Zinc-air Battery. Chem. Education J. 13, (2009).
3. Hilder, M., Winther-Jensen, B. & Clark, N. B. Paper-based, printed zinc-air battery. J. Power Sources 194, 1135-1141 (2009).
4. Hilder, M., Winther-Jensen, B. & Clark, N. B. The effect of binder and electrolyte on the performance of thin zinc-air battery. Electrochimica Acta 69, 308-314 (2012).
5. Suren, S. & Kheawhom, S. Development of a High Energy Density Flexible Zinc-Air Battery. J. Electrochem. Soc. 163, A846 (2016).
6. Wang, T. et al. Silver nanoparticle-decorated carbon nanotubes as bifunctional gas-diffusion electrodes for zinc-air batteries. J. Power Sources 195, 4350-4355 (2010).
7. Zhang, J. et al. High-Energy-Density Zinc-Air Microbatteries with Lean PVA-KOH-K2CO3 Gel Electrolytes. ACS Appl. Mater. Interfaces 15, 6807-6816 (2023).
8. Liu, Q. et al. High-Performance PVA/PEDOT: PSS Hydrogel Electrode for All-Gel-State Flexible Supercapacitors. Adv. Mater. Technol. 6, 2000919 (2021).
9. Ma, T. & Mackenzie, J. D. Fully printed, high energy density flexible zinc-air batteries based on solid polymer electrolytes and a hierarchical catalyst current collector. Flex. Print. Electron. 4, 015010 (2019).
10. Sun, W et al. A rechargeable zinc-air battery based on zinc peroxide chemistry. Science, 371 (6524), 46-51. (2021)

1. An electrochemical sensor for sensing oxygen, the sensor comprising:
an anode comprising:
an anode active layer;
a cathode in ionic communication with the anode comprising:
a cathode active layer;
a separator positioned between the anode and the cathode;
wherein the separator comprises an electrolyte and establishes ionic communication between the anode and the cathode; and
an electronic unit configured to electrically couple the anode with the cathode and to receive from the anode and the cathode one or more electrical signals indicative of a level of oxygen in an ambient environment.

2. The sensor of claim 1, wherein the anode comprises an anode substrate and a first current collector; wherein the anode substrate comprises an electrically insulating material; and/or wherein the anode substrate comprises a polymer, a glass, or any combination thereof.

3. (canceled)

4. (canceled)

5. (canceled)

6. The sensor of claim 2, wherein the anode active layer is a printed anode active layer, the printed anode active layer comprises an anode ink printed on the first current collector, and the anode ink comprises a metal and/or a metal alloy; wherein the metal or metal alloy comprises Zn, Mg, Li, Al, Fe, Na or any combination of these and/or wherein the anode ink comprises at least 40% metal or metal alloy by mass.

7. (canceled)

8. (canceled)

9. The sensor of claim 6, wherein the anode ink comprises a binder and a solvent; wherein the binder comprises polycaprolactone, polyvinylpyrrolidone, polyvinyl alcohol, polyvinyl acetate, polytetrafluoroethylene, polyvinylidene fluoride, pyridine-styrene-butadiene rubber, Poly(3-hydroxybutyrate-co-3-hydroxyvalerate), a bees wax, or a combination thereof; and/or wherein the solvent comprises anisole, tetrahydrofuran, N-methyl-2-pyrrolidone, acetone, isopropanol, water, or a combination thereof.

10. (canceled)

11. (canceled)

12. The sensor of claim 6, wherein the anode ink comprises an additive comprising zinc oxide, a carbon material, bismuth oxide, lead, indium, styrene butadiene, sodium silicate, polycarbonate, or any combination of these.

13. The sensor of claim 2, wherein the first current collector comprises an anode current collector ink; and/or wherein the first current collector and/or anode current collector ink comprises Ag, Au, Ni, stainless steel, carbon, or a combination thereof.

14. (canceled)

15. The sensor of claim 1, wherein the cathode further comprises a cathode substrate and a second current collector; wherein the cathode substrate comprises a gas permeable cathode substrate that is permeable to oxygen; and wherein the cathode substrate comprises an electrically insulating material; and wherein the gas permeable cathode substrate comprises a gas permeable membrane, and the gas permeable membrane comprises polypropylene, polytetrafluoroethylene, paper, or any combination thereof.

16. (canceled)

17. (canceled)

18. The sensor of claim 15, wherein the second current collector comprises a cathode current collector ink; wherein the second current collector and/or the cathode current collector ink comprises Ag, stainless steel, Ni, Nickle mesh, or a combination thereof.

19. (canceled)

20. The sensor of claim 15, wherein the cathode active layer is a printed cathode active layer, and the printed cathode active layer comprises a cathode ink printed on the second current collector; wherein the cathode ink comprises a binder, a solvent, and an active material; wherein the binder comprises polycaprolactone, polyvinylpyrrolidone, polyvinyl alcohol, polyvinyl acetate, polytetrafluoroethylene, polyvinylidene fluoride, pyridine-styrene-butadiene rubber, Poly(3-hydroxybutyrate-co-3-hydroxyvalerate), a bees wax, or a combination thereof; and/or wherein the solvent comprises anisole, tetrahydrofuran, N-methyl-2-pyrrolidone, acetone, isopropanol, water, or a combination thereof.

21. (canceled)

22. (canceled)

23. (canceled)

24. The sensor of claim 1, wherein the cathode active layer comprises an oxygen reduction catalyst; and/or wherein the oxygen reduction catalyst comprises carbon ink, carbon paper, carbon nanotubes, silver nanoparticles, perovskites, polytetrafluoroethylene, a metal, a metal oxide, a metal calcite, a metal carbide, a metal nitride, or any combination thereof.

25. (canceled)

26. The sensor of claim 1, wherein the anode and the cathode are operable via the electronic unit to generate the one or more electrical signals indicative of the level of oxygen in the ambient environment using amperometric detection, potentiometric detection, impedimetric detection, voltammetric detection, or any combination thereof and/or wherein the anode and the cathode are operable to generate the one or more electrical signals indicative of the level of oxygen in the ambient environment by short circuiting the sensor and measuring the recovery time or by drawing a controlled current and measuring the potential of the sensor.

27. (canceled)

28. (canceled)

29. (canceled)

30. (canceled)

31. (canceled)

32. (canceled)

33. The sensor of claim 1, wherein the electrolyte comprises potassium hydroxide, sodium chloride, lithium chloride, ammonium chloride, zinc chloride, zinc sulfate, water, dimethyl sulfoxide, glass fiber, zinc trifluoromethanesulfonate, a hydrogel, an oranogel, or any combination thereof and/or wherein the separator comprises polypropylene, glass fiber, paper, or any combination thereof.

34. (canceled)

35. (canceled)

36. The sensor of claim 1, wherein the sensor comprises a housing comprising one or more air inlets, wherein the one or more air inlets comprises one or more holes, and wherein the one or more air inlets are configured to control a rate of diffusion of a sample gas into the sensor to detect oxygen in the sample gas; and/or wherein the housing comprises acrylonitrile styrene acrylate, a plastic material, a metal material, or a combination thereof.

37. (canceled)

38. The sensor of claim 1, comprising a gas diffusion membrane configured to control a rate of diffusion of oxygen from the sample to the cathode; and/or wherein the gas diffusion membrane comprises expanded polytetrafluoroethylene, nylon, neoprene, polytetrafluoroethylene, or a combination thereof.

39. (canceled)

40. A method of sensing oxygen, the method comprising:
providing an electrochemical sensor comprising:
an anode, a cathode, and a separator comprising an electrolyte positioned between the anode and the cathode;
wherein the anode and the cathode are electrically coupled via an electronic unit configured to receive one or more electrical signals indicative of a level of oxygen and in ionic communication via the separator;
wherein the anode is an active anode layer comprising a metal or metal alloy;
wherein the cathode is an active cathode layer comprising an oxygen reduction catalyst;
providing a sample,
controlling a rate of diffusion of oxygen from the sample into the electrochemical sensor;
delivering oxygen to the cathode such that the oxygen at least partially contacts the oxygen reduction catalyst; and
measuring one or more electrical signals indicative of the level of oxygen in the sample gas with the electronic unit.

41. (canceled)

42. The method of claim 40, wherein the one or more electrical signals comprises a voltage, a current, an impedance, an open circuit potential, or any combination thereof; and/or wherein the anode and the cathode are operable to generate the one or more electrical signals indicative of the level of oxygen using amperometric detection, potentiometric detection, impedimetric detection, voltammetric detection or any combination of these.

43. (canceled)

44. The method of claim 42, wherein amperometric detection comprises applying a voltage bias across the anode and the cathode after delivering oxygen to the cathode and measuring a resulting output current indicative of oxygen concentration in the sample; and/or wherein the applied voltage bias is greater than or equal to 0.5 V and less than or equal to 1.2 V.

45. (canceled)

46. (canceled)

47. (canceled)

48. The method of claim 42, wherein impedimetric detection comprises applying a small-amplitude alternating voltage across the anode and the cathode and measuring a resulting current response to determine impedance of the sensor after delivering oxygen to the cathode, the impedance being indicative of oxygen concentration in the sample; and/or wherein the alternating voltage is sinusoidal, and the impedance is determined as a ratio of the applied voltage to the measured current as a function of frequency, wherein the sinusoidal voltage is applied at a frequency of between 0.1 Hz and 1 MHz.

49. (canceled)

50. (canceled)

51. The method of claim 40, wherein the one or more electrical signals is generated by short-circuiting the electrochemical sensor after delivering oxygen to the cathode and measuring the recovery time of a cell potential; and/or wherein the one or more electrical signals is generated by applying a controlled current to the sensor after delivering oxygen to the cathode and measuring a resulting potential between the anode and the cathode.

52. (canceled)

53. (canceled)

54. The method of claim 40, wherein the anode comprises a printed anode comprising an anode ink; and/or wherein the cathode comprises a printed cathode comprising a cathode ink.

55. (canceled)

56. The method of claim 40, wherein the sensor comprises a housing and the housing comprises one or more air inlets; wherein the housing comprises a water-tight housing; and/or wherein the sample comprises a soil sample and the providing comprises burying the sensor in the soil sample.

57. (canceled)

58. (canceled)

59. A method of fabricating an electrochemical sensor for sensing oxygen, the method comprising:
printing an anode ink on a first current collector layer to form a printed anode active layer;
printing a cathode ink on a second current collector layer to form a printed cathode active layer;
providing a separator disposed between the printed anode active layer and the printed cathode active layer; wherein the separator comprises an electrolyte;
assembling the sensor such that the printed anode active layer and the printed cathode active layer are in ionic communication via the separator and electrically coupled via an electronic unit configured to receive one or more electrical signals indicative of a level of oxygen in an ambient environment.

60. The method of claim 59, wherein the assembling comprises sealing the printed anode active layer, the printed cathode active layer, and the separator together; wherein the sealing is carried out using an airtight adhesive, a pouch, plastic welding, coin cell packaging, or any combination thereof; and/or wherein the pouch comprises a gas permeable polymer.

61. (canceled)

62. (canceled)

63. (canceled)

64. (canceled)

65. The method of claim 59, further comprising first printing a first current collector ink on an anode substrate thereby forming the first current collector layer; and/or further comprising second printing a second current collector ink on a cathode substrate thereby forming the second current collector layer; and wherein the printing comprises depositing the cathode ink, the anode ink, the cathode current collector ink, and/or the anode current collector ink via stencil printing, screen printing, thick-film printing, or any combination thereof.

66. (canceled)

67. (canceled)

68. The method of claim 65, wherein the cathode substrate is permeable to oxygen.
